(19) United States
(12) Patent Application Publication
(10) Pub. No.: US 2025/0228215 A1
(43) Pub. Date: Jul. 17, 2025

(54) MODULATION OF ANIMAL BEHAVIOUR

(71) Applicant: Max-Planck-Gesellschaft zur Förderung der Wissenschaften E.V., Munchen (DE)

(72) Inventors: Martin Christoph WIKELSKI, Radolfzell (DE); Timm Alexander WILD, Radolfzell (DE); Georg HEINE, Radolfzell (DE); Berne VORNEWEG, Radolfzell (DE); Dina Kea Noanoa DECHMANN EL ARBI, Radolfzell (DE); Ursula Rosa MÜLLER, Radolfzell (DE); Brigitta Monika KEEVES VON WOLF, Radolfzell (DE); Michael Oliver QUETTING, Radolfzell (DE); Florian GRÜTZMACHER, Rostock (DE); Christian HAUBELT, Rostock (DE); Erik KÜHN, Rostock (DE)

(73) Assignee: Max-Planck-Gesellschaft zur Förderung der Wissenschaften E.V., Munchen (DE)

(21) Appl. No.: 18/604,810

(22) PCT Filed: Sep. 13, 2022
(86) PCT No.: PCT/EP2022/075448

§ 371 Date: Mar. 14, 2024

(30) Foreign Application Priority Data
Sep. 14, 2021 (EP) 21196592.6

(51) Int. Cl. A01K 27/00; A01K 11/00; A01M 29/16

(52) U.S. Cl. CPC A01K 27/009; A01K 11/006; A01M 29/16

(57) ABSTRACT

The present solution relates to animal behaviour modulation of at least one first animal to be carried out on a device attached to a second animal. The device comprises a memory, at least one sensor, a processor, and a signal generator. The method comprises: storing, in the memory, at least one extracted characteristic feature of training data of at least one monitored physical quantity in at least one degree of freedom in momentum, specific to at least one behaviour of the second animal and/or at least one local environmental condition related to the second animal; monitoring, by the at least one sensor, the at least one monitored physical quantity of the second animal and/or the at least one local environmental condition related to the second animal; determining, by the processor, a type of behaviour of the second animal; and generating, by the signal generator, a warning signal.

### CROSS-REFERENCE TO RELATED APPLICATION

This application claims the benefit of priority under 35 U.S.C. § 120 as a continuation of International Patent Application No. PCT/EP2022/075448, filed on Sep. 13, 2022, which claims priority to EP Application Serial No. 21196592.6, filed on Sep. 14, 2021, the disclosure of each of which is incorporated herein by reference in its entirety.

### TECHNICAL FIELD

The present disclosure relates to a method and a device for animal behaviour modulation.

### BACKGROUND

Domestic cats are very common pets in most industrialized countries in the world. In Germany alone, about 30% of households have pet cats. Most of these cats are allowed to roam freely throughout the neighbourhoods. Recently, it has been discovered that pet cats supposedly kill a large number of small vertebrates, including songbirds in the hundreds of millions, rodents in the hundreds of millions and a vast number of large insects. Due to the human presence in all areas, this has been considered a major problem for the conservation of our avifauna, resulting in calls to either cull cats, keep them permanently inside or tax the holding of cats.

### SUMMARY

A domestic cat roaming through gardens and forests are not under continuous observation and thus cannot be prevented from their instinct of hunting and killing their prey. To prevent cats from killing other animals, several methods are currently in use: Necklaces with little bells, huge flashy necklaces that make cats extremely obvious, and the declawing of cats by surgical means. However, none of these measures is successful and cats still hunt and kill birds or other vertebrates. Moreover, these measures do not differentiate between the hunting of cats for specific prey, e.g., birds and rodents. Accordingly, in scenarios in which hunting and killing rodents is appreciated and the hunting and killing of birds is not, the known methods may not be useful. Although there are systems using sensors to determine/analyse animal behaviour, those system have certain disadvantages.

For example, specific animal behaviour or differences between animal behaviour sometimes only reveals by subtle movements or changes in the movement, respectively. In other cases, a specific behaviour is even only characterized by small muscular movements/contractions while the animal is overall in a stationary position. The detection of such subtle differences requires a high resolution of the measured data and thus demands a high computational power which is complicated to be combined on a single self-sufficient device. Another prerequisite of preventing a cat from killing another animal is that the detection of hunting behaviour (that may be specific for a distinct prey) must be very fast allowing to warn the attacked animal (or the animal to be attacked) timely and thus providing the chance to escape. In other words, systems that may be used to detect animal behaviour often require long processing times or even require that the obtained data is saved in the storage and then downloaded from the device after a certain observation period. Some systems may allow a wireless data transfer to external analysis systems, however, such a transfer requires continuous, fast and stable connection that may not be available for animals, such as domestic cats, that move freely (and are not, for example, restricted by a barn or enclosures) in large area. Thus, present systems are not suitable to prevent hunting behaviour of a cat and allow flight/escape behaviour of the prey.

Furthermore, methods to prevent cats from killing other animals should not drastically disturb the cat in their natural movements and behaviour.

Therefore, there is a need to develop new methods that efficiently prevent cats from killing other animals, in particular birds, and overcome the above-mentioned obstacles.

In addition, domestic cats are generally allowed to move freely in the apartments and gardens of their owners. It is therefore a general problem that cats are found at places and/or on furniture where they are actually not supposed to be. Since cat owners cannot constantly observe their cats, new methods are required that prevent, in particular in the absence of their owners, cats from entering said places and/or furniture.

It is also not unusual that domestic cats do not appear at their home for days or even longer periods. Therefore, it is often complicated for cat owners to control the health of their cats.

This is even further complicated by the fact that many cat owners are not experienced with diseases of cats and how such diseases can be identified/diagnosed. Accordingly, also new methods are required that (automatically) detect potential diseases of cats and inform the cat owner thereof.

The present inventors provide new methods and devices that overcome the above-mentioned obstacles in the field of animal behaviour detection and modulation. Specifically, the inventors combined, inter alia, the use of highly sensible acceleration sensors with high-power processors on a single device with artificial intelligence and machine learning. This allows that the obtained sensor data (e.g., from an accelerometer) can be processed at a high resolution and within a very short time in a self-sufficient manner, i.e., without requiring data transfer and/or connection to an external system.

In the following, example embodiments of the solution will be described. It is noted that some aspects of any one of the described embodiments may also be found in some other embodiments unless otherwise stated or obvious. However, for increased intelligibility, each aspect will only be described in detail when first mentioned and any repeated description of the same aspect will be omitted.

The present solution relates to a method for animal behaviour modulation of at least one first animal to be carried out on a device attached to a second animal, the device comprising storing, in the memory, at least one extracted characteristic feature of training data of at least one monitored physical quantity in at least one degree of freedom in momentum, specific to at least one behaviour of the second animal and/or at least one local environmental condition related to the second animal; monitoring, by the at least one sensor, the at least one monitored physical quantity of the second animal and/or the at least one local environmental condition related to the second animal; determining, by the processor, a type of behaviour of the second animal based on the at least one monitored physical quantity of the second animal and/or the at least one local environmental condition related to the second animal, and the stored at least one extracted characteristic feature of the training data; and generating, by the signal generator, a warning signal based on the determining a first set type of behaviour of the second animal, so that the warning signal induces the behaviour modulation of the at least one first animal.

Herein disclosed is a new method and device that allows to prevent domestic cats from hunting and/or killing of their prey, in particular songbirds, independently of the intervention of humans. This is achieved by identifying the behaviour of a cat and generating a warning signal when the cat exhibits a specific behaviour, in particular hunting behaviour. To this end, the inventors combined sensors to constantly monitor the motion of the cat with artificial intelligence for automatic identification of the corresponding behaviour. Accordingly, the present solution does not interfere with the natural behaviour of the cat and only activates when a specific behaviour is detected. This allows the perfectly timed behaviour modulation of the prey, in particular induction of flight behaviour, when a hunting cat is approaching without constantly interfering with the natural behaviour of the cat as well as of the prey. It is especially advantageous that the present solution is able to distinguish between the behaviour of hunting a specific prey. This allows to adjust specifically which type of prey should be warned.

In one embodiment, the at least one first animal is a bird, in particular a songbird, and the second animal is a domestic cat.

Accordingly, the method of the present solution relates, inter alia, to a method for animal behaviour modulation of at least one bird, in particular a songbird, to be carried out on a device attached to a domestic cat, the device comprising a memory, at least one sensor, a processor, and a signal generator.

The method comprises storing, in the memory, at least one extracted characteristics feature of training data of at least one monitored physical quantity in at least one degree of freedom in momentum specific to at least one behaviour of the second animal, in particular behaviour of hunting a bird, of the domestic cat and/or at least one local environmental condition related to the second animal wherein the at least one extracted characteristic feature of the training data relates to the at least one monitored physical quantity of the domestic cat, wherein the at least one local environmental condition is a quantity to which measured value of local environment is assigned; monitoring, by the at least one sensor, the at least one monitored physical quantity of the domestic cat, wherein the at least one monitored physical quantity is a quantity to which a measured value induced by the motion of the domestic cat is assigned; determining, by the processor, a type of behaviour, in particular behaviour of hunting a bird, of the domestic cat based on the at least one monitored physical parameter of the domestic cat and the stored at least one extracted feature characteristics of training data of at least one monitored physical quantity in at least one degree of freedom in momentum, specific to at least one behaviour, in particular behaviour of hunting a bird, of the domestic cat and/or at least one local environmental condition related to the second animal; and generating, by the signal generator, a warning signal based on the determining a first set type of behaviour, in particular behaviour of hunting a bird, of the domestic cat, so that the warning signal induces the flight behaviour of the at least one bird, in particular a songbird.

Various embodiments may advantageously implement the following features:

According to one embodiment, the behaviour of the second animal is not modulated. According to an embodiment, the behaviour of the second animal is not modulated, wherein not modulated means that the behaviour of the second animal during the warning sound and/or carrying the device is not different from the behaviour in the absence of the warning sound and/or carrying the device and, in particular, this may not exclude that the second animal shows a reaction to the generated warning signal, wherein said reaction may be but is not limited to a startle response and/or the termination of hunting behaviour. According to one embodiment, the behaviour of the second animal is modulated. According to an embodiment, the behaviour of the second animal is modulated, in particular a startle response and/or termination of hunting behaviour is induced. According to one embodiment, the behaviour of the second animal is modulated by the generated warning signal. According to one embodiment, the behaviour of the second animal is modulated by conditioning, in particular operant/instrumental conditioning. According to an embodiment, the behaviour of the second animal is modulated by a stimulus applied to the second animal. According to one embodiment, the stimulus applied to the second animal is an adverse stimulus. According to an embodiment, the adverse stimulus is a sound, in particular a sound that is specifically audible to the second animal. According to one embodiment, the adverse stimulus applied to the second animal is an electric shock, in particular a foot shock.

According to one embodiment, the behaviour modulation of the at least one first animal comprises the induction of flight behaviour. According to an embodiment, the flight behaviour comprises running and/or flying. According to one embodiment, behaviour modulation of the at least one first animal comprises the generation of warning sounds by the at least one first animal.

According to one embodiment, the at least one first animal is prey. According to an embodiment, the at least one first animal is a bird, rodent, amphibia and/or an insect. In one embodiment, the at least one first animal is a bird. In an embodiment, the at least one first animal is a passerine. In another embodiment, the at least one first animal is a songbird. According to one embodiment, the at least one first animal is a rodent. According to an embodiment, the at least one first animal is a mouse, a rat, a hamster and/or a squirrel. According to one embodiment, the at least one first animal is an insect.

According to an embodiment, the second animal is a predator. According to one embodiment, the second animal belongs to the biological order of Carnivora. According to an embodiment, the second animal is a felid. According to one embodiment, the second animal is a feline. According to an embodiment, the second animal belongs to the biological genus Felis. According to one embodiment, the second animal is a domestic cat (Felis catus).

According to one embodiment, the at least one sensor monitoring the at least one motion parameter of the second animal comprises or is a Micro-Electro-Mechanical Systems, MEMS, in particular an inertial measurement unit, IMU, a magnetometer, a microphone, and/or a pressure sensor. According to an embodiment, the inertial measurement unit comprises or is an accelerometer.

According to an embodiment, the at least one sensor monitors the forces exerted on the sensors.

According to an embodiment, the monitored at least one motion parameter is an acceleration in x, y, and z direction in Euclidean space.

According to an embodiment, the value of the at least one motion parameter is determined by the motion of the device attached to the second animal along the vertical (yaw), transverse (pitch) and/or longitudinal axis (roll).

According to an embodiment, the at least one local environmental condition comprises or is a pressure, a humidity, a sound pressure in the vicinity of the second animal and/or the position of the animal as determined by GPS.

According to an embodiment, the values assigned to the at least one monitored physical quantity in at least one degree of freedom in momentum may be in any form, in particular analog and/or digital, and is induced by the physical movements of the second animal to which the device is attached. According to an embodiment, a sensor or a plurality of sensors monitor at least one monitored physical quantity and/or at least one environmental condition related to the second animal over a set range of period or an indefinite period of time and the values assigned to the at least one physical quantity and/or the at least environmental condition form training data. According to an embodiment, the values assigned to the at least one monitored physical quantity is communicated externally from the communication module to the external communication module. According to an embodiment, the values assigned to the at least one monitored physical quantity and/or the at least one environmental condition is pre-processed, in particular truncated and/or filtered in time-domain and/or frequency domain. According to an embodiment, the values assigned to the at least one monitored physical quantity or the pre-processed data are extracted to characteristic features, then categorized or classified into different behaviour motions of the second animal by humans, in particular by examining the at least one extracted characteristic features or the pre-processed data. According to an embodiment, the categorization or classification is conducted by humans by examining the at least one physical quantity in conjunction and/or the at least one local environment in conjunction with another monitored data, in particular a video of behaviour motions of the second animal temporally corresponding to the values assigned to the at least one monitored physical quantity and/or the at least one local environment and assigning behavioural classes and/or extracting at least one characteristic feature. According to an embodiment, the classification or categorization is performed by the processor, in particular machine learning algorithm automatically. According to an embodiment, the values assigned to at least one monitored physical quantity and/or pre-processed data and/or categorized data is part of or is the at least one extracted characteristic feature of training data stored in the memory.

According to an embodiment, the first set type of behaviour of the second animal is a hunting behaviour. According to an embodiment, the first set type of behaviour of the second animal is hunting behaviour for a specific animal. According to an embodiment, the first set type of behaviour of the second animal is hunting an animal selected from the group comprising birds, rodents, amphibia and insects. In an embodiment, the first set type of behaviour of the second animal is hunting a bird. In an embodiment, the first set type of behaviour of the second animal is hunting a passerine. In an embodiment, the first set type of behaviour of the second animal is hunting a songbird. According to an embodiment, the first set type of behaviour of the second animal is hunting a rodent. According to an embodiment, the first set type of behaviour of the second animal is hunting a rodent, wherein the rodent is a mouse, a rat, a hamster and/or a squirrel. According to an embodiment, the first set type of behaviour of the second animal is hunting an insect.

According to an embodiment, the warning signal is not generated based on a determined second set type of behaviour of the second animal. According to an embodiment, the second set type of behaviour of the second animal is different form the first set type of behaviour. According to an embodiment, the second set type of behaviour of the second animal is a specific hunting behaviour. According to an embodiment, the second set type of behaviour of the second animal is hunting a rodent. According to an embodiment, the second set type of behaviour of the second animal is hunting a rodent, wherein the rodent is a mouse, a rat, a hamster and/or a squirrel.

According to an embodiment, the warning signal is not generated based on a determined local environmental condition, in particular, a specific position of the second animal. According to an embodiment, the warning signal is only generated based on a determined set type of behaviour of the second animal and a simultaneously determined local environmental condition.

According to an embodiment, the warning signal is a sound that is at least audible to the at least one first animal. According to an embodiment, the warning signal is a sound, wherein the sound has frequency of 50 Hz to 12 kHz. According to an embodiment, the warning signal is a sound, wherein the sound has a frequency of 1 to 5 kHz. According to an embodiment, the warning signal is a non-naturally occurring sound. According to an embodiment, the non-naturally occurring sound has a constant frequency or comprises a plurality of different frequencies. According to an embodiment, the warning signal mimics a naturally occurring warning sound. According to an embodiment, the warning signal mimics a naturally occurring warning sound of birds. According to an embodiment, the mimicked naturally occurring warning sound of birds is a ground-specific warning sound. According to an embodiment, the mimicked naturally occurring warning sound of birds is an air-specific warning sound. According to an embodiment, the mimicked naturally occurring warning sound is the alarm call of the male Red-winged Blackbirds (Agelaius phoeniceus).

According to an embodiment, the signal generator comprises or is a piezoelectric transducer.

According to an embodiment, the at least one sensor comprises a processor that is not the processor of the device. According to an embodiment, the at least one sensor or the processor in the at least one sensor comprises a memory to store the at least one extracted characteristic feature of training data, in particular a non-volatile memory including a flash memory, read-only memory, random access memory, and/or the like. According to an embodiment, the processor in the at least one sensor communicates, bidirectionally, with the processor of the device, other processors in other sensors, and memory of the device. According to an embodiment, the communication comprises information pertaining to available computational resources and storage. According to an embodiment, the processor in the at least one sensor processes the at least one monitored physical quantity and/or local environmental condition and extracts the at least one characteristic feature. According to an embodiment, the at least one sensor comprises a processor and the device has a processor, wherein the processor in the at least one sensor is not the same as the processor of the device. Such embodiment is favourable in that the computational load can be balanced among the plurality of processors and reduces data exchange rate, which in turn reduces power consumption and heat dissipation.

According to an embodiment, the processor of the device is the only processor. According to an embodiment, the processor in the device is part of system in a package. According to an embodiment, the processor in the device is a processor produced on a separate chip than the chip of the device. Such embodiment is favourable in that the processor is computationally powerful.

According to an embodiment, the at least one extracted characteristic feature of training data is a processed parameter based on the at least one monitored physical quantity in at least one degree of freedom in momentum, specific to at least one behaviour of the second animal and/or at least one local environmental condition related to the second animal, in particular standard deviation, skewness, kurtosis, value range, maximum value, minimum value, dominant frequency, mean crossing rate, zero crossing rate, and/or the like.

According to an embodiment, the behaviour of the second animal is determined by the person skilled in the art, in particular a behavioural biologist and/or a veterinarian. According to an embodiment, the at least one behaviour of the second animal comprises a specific pattern of motions. Non-limiting examples of the at least of behaviour of the second animal are hunting, running, grooming, walking, sleeping, or the like. In an embodiment, hunting behaviour of the domestic cat is specific for a specific type of prey. According to an embodiment, the training data obtained for a specific species, in particular a domestic cat, can be used for determining a type of behaviour of a different species, in particular members of the same biological family, in particular felids.

### Active Modulation of Animal Behaviour

The present solution may also be used to actively modulate the behaviour of the second animal. This can be done by conditioning the second animal to a specific stimulus such that the second animal exhibits a certain behaviour in the presence of said specific stimulus. Such certain behaviour may be returning to the home the second animal.

According to an embodiment, the stimulus applied to the second animal is non-adverse stimulus. According to an embodiment, the non-adverse stimulus is generated, by the signal generator, based on a manual activation, in particular by the cat owner. According to an embodiment, the manual activation of the signal generator is based on a wirelessly received signal from a device, in particular the mobile phone of the cat owner. According to an embodiment, the device attached to the second animal further comprises a receiver, wherein the receiver is used to receive the wirelessly transmitted signal from a device, in particular the mobile phone of the cat owner. According to an embodiment, the wirelessly transmitted signal is based on the Bluetooth LE and/or WiFi technology. According to an embodiment, the non-adverse stimulus is a sound, in particular a clicker sound. According to an embodiment, the non-adverse stimulus is a stimulus to which the second animal is conditioned to exhibit a specific behaviour. According to an embodiment, the specific behaviour to which the second animal is conditioned is moving to a specific location, in particular their home. According to an embodiment, the volume of the non-adverse sound is manually adjustable via the device that transmits the wireless signal. According to an embodiment, the non-adverse sound is used to identify the location of the second animal indoors and/or outdoors.

### Location-Based Animal Behaviour Modulation

The present method may be further used to prevent the second animal from entering and/or leaving a certain area and/or preventing an animal from exhibiting a certain behaviour within said area.

According to an embodiment, the method is carried out on a system comprising the device attached to the second animal and at least one communication device, the method comprises communicating data wirelessly between the device attached to the second animal and the at least one communication device; determining the distance between the device attached to second animal and the at least one communication device based on the communicated data; determining, by the device attached to the second animal, a type of behaviour of the second animal, generating a stimulus when the distance exceeds a preset boundary and/or a set type of behaviour is determined; and modulating, via the generated stimulus, the behaviour of the second animal.

According to an embodiment, the stimulus is generated, by the at least one communication device and/or the device attached to the second animal, by determining a distance below a set threshold distance between the device attached to second animal and the at least one communication device.

According to an embodiment, the distance of the second animal to the at least one communication device (‘proximity buttons’) is determined based on wirelessly transmitted signals, in particular based on residual signal strength indicator RSSI values correlating to the distance.

According to an embodiment, the set type of behaviour is scratching on an object, in particular furniture, defecation behaviour and/or hunting behaviour.

According to an embodiment, the method further comprises identifying, via GPS, the position of the animal; and generating, by the device attached to the second animal, a stimulus based on determining a set position of the second animal.

According to an embodiment, the stimulus that modulates the behaviour of the second animal is an adverse stimulus.

According to an embodiment, the adverse stimulus is a sound and/or an electric shock.

According to an embodiment, the intensity of the generated stimulus increases with decreasing distance to the communication device and/or set position; and/or with increasing time at a distance below a set threshold distance to the communication device and/or at the set position. According to an embodiment, modulating the behaviour of the second animal is modulating the second animal to increase the distance to the communication device and/or the set position. According to an embodiment, the generated stimulus is a stimulus to which the second animal is conditioned/trained to exhibit a specific behaviour, in particular returning to their home. According to an embodiment, the stimulus to which the second animal is conditioned/trained is a non-adverse stimulus. According to an embodiment, the non-adverse stimulus is a clicker sound. According to an embodiment, the stimulus that modulates the behaviour of the second animal conditions the second animal to avoid the specific object and/or location. According to an embodiment, the signal is generated by manual activation, in particular via wireless communication, of the device attached to the animal and/or the communication device.

### Determination of the Health-Status

The present method can also be used to identify the health status of the second animal. In this embodiment of the solution, a type of health-related behaviour of the second animal is determined in addition to, for example, hunting behaviour.

According to an embodiment, the method further comprises storing, in the memory, at least one characteristic feature of training data of at least one monitored physical quantity in at least one degree of freedom in momentum, specific to at least one health-related behaviour of the second animal and/or at least one local environmental condition related to the second animal; determining, by the processor, a type of health-related behaviour of the second animal based on the at least one monitored physical quantity of the second animal and/or the at least one local environmental condition related to the second animal, and the stored at least one characteristic feature of the training data; and identifying, by the processor, the health status of the second animal based on the determined type of health-related behaviour of the second animal.

It can be indicative for an abnormal health status when a certain behaviour is exhibited more often than normal. For example, it is known that also healthy animals cough from time to time without being critically ill. Yet, extensive coughing may be indicative for a severe illness. Therefore, the present method is able to determine whether the occurrence of a specific health-related behaviour is indicative for a normal or abnormal health status.

According to an embodiment, identifying the health status of the second animal comprises or is determining, by the processor, when the determined type of the health-related behaviour corresponds to a set type of health-related behaviour, whether the determined type of health-related behaviour is indicative of a normal health status or an abnormal health status, in particular by comparing at least one parameter related to the determined type of health-related behaviour to a reference value.

According to an embodiment, the at least one parameter is a frequency of occurrence and/or duration of the determined type of health-related behaviour, a magnitude of the at least one monitored physical quantity, and/or a waveform of the at least one monitored physical quantity.

According to an embodiment, the reference value is a range of values and is based on the average at least one parameter specific to the at least one health-related behaviour of the individual second animal and/or a population of individuals of the same species of the second animal.

According to an embodiment, the at least one health-related set type of behaviour is drinking behaviour. According to an embodiment, the at least one health-related set type of behaviour is scratching behaviour. According to an embodiment, the at least one health-related set type of behaviour is the interest in the anorectal region. According to an embodiment, the at least one health-related set type of behaviour is defection behaviour. According to an embodiment, the at least one health-related set type of behaviour is coughing. According to an embodiment, the at least one health-related set type of behaviour is grooming, in particular excessive grooming.

Another way of the solution to identify an abnormal health status of an animal is to determine a specific health-related type of behaviour that is only observed during illness. According to an embodiment, identifying the health status of the second animal further comprises determining, by the processor, that the determined type of health-related behaviour is indicative of an abnormal health status when the determined type of health-related behaviour corresponds to a set type of health-related behaviour specific for an abnormal health status indicated by the stored at least one characteristic feature.

The number of diseases to be identified is not particularly limited.

According to an embodiment, the identified abnormal health status is a renal insufficiency, flea infestations, worm infestations and/or filled anal glands, and/or gastric- and intestinal problems.

According to an embodiment, the identifying the renal insufficiency is based on determining a drinking behaviour specific for renal insufficiency and/or a difference of the determined drinking behaviour compared to the reference value, in particular, increased frequency and/or duration of drinking behaviour.

According to an embodiment, the identifying the worm infestations and/or filled anal glands is based on determining an interest in the anorectal region specific for worm infestations and/or filled anal glands, and/or a difference of the determined interest in the anorectal region compared to the reference value, in particular, increased frequency and/or duration of the in the anorectal region.

According to an embodiment, the identifying gastric- and intestinal problems is based on determining a defecation behaviour specific for gastric- and intestinal problems and/or a difference of the determined defecation behaviour compared to the reference value, in particular, increased or reduced frequency and/or duration of the defecation behaviour.

According to an embodiment, the method further comprises sending a warning message, in particular to a person responsible for the animal and/or a veterinarian. According to an embodiment, the warning message is an acoustic warning message is generated by a Piezo speaker comprised in the device. According to an embodiment, the warming message is a wirelessly transmitted digital warning message sent via including, but not limited to, LPWAN technologies such as LoRa, Sigfox, WiFi, or Bluetooth LE.

According to an embodiment, the method further comprises generating a stimulus, by the device attached to the second animal, wherein the stimulus is a stimulus to which the animal is conditioned to exhibit a specific behaviour.

According to an embodiment, the method further comprises storing, in the memory, at least one characteristic feature of the determined behaviours.

According to an embodiment, the stimulus is generated by manual activation of the device attached to the second animal, in particular via wireless communication, is generated by determining a set type of health-related behaviour and/or is generated by identifying a set type of health status.

According to an embodiment, the specific behaviour is moving to a specific position, in particular the home of the second animal.

According to an embodiment, the stimulus is a clicker sound.

According to an embodiment, the animal behaviour modulation device is a necklace, a housing or the like. According to an embodiment, the animal behaviour modulation device is attached to a necklace. According to an embodiment, the animal behaviour modulation device is located inside a necklace. According to an embodiment, the device implanted under the skin of the second animal.

According to an embodiment, the processor discriminates the first set type of behaviour from the second set type of behaviour, in particular machine learning algorithm classifies the monitored at least one monitored physical quantity and/or the at least one local environmental condition based on the stored at least one extracted characteristic feature, more particularly by using statistical classification algorithms including K-Nearest Neighbours, decision tree, and support vector machine. According to an embodiment, the classified or categorized motions of the second animal or a plurality of classified or categorized motions of the second animal represent the first set type of behaviour corresponding to hunting the first animal, e.g. a songbird or the second set type of behaviour corresponding to hunting an animal different from the first animal, e.g. a mouse or a third set type of behaviour that is not the first and the second set type of behaviours. According to an embodiment, the number of set types of behaviour is not limited. According to an embodiment, the processor determines the behaviour of the second animal based on the classified or categorized motions of the second animal or the plurality of classified or categorized motions the second animal and feeds the control signal to the piezoelectric transducer which may or may not generate a warning signal. According to an embodiment, the communication module is a wireless or wired communication network. According to an embodiment, the communication module exchanges information with the external communication module unidirectionally or bidirectionally. According to an embodiment, the communication module is a long-range telemetry module in particular, a long range module (LoRA), Sigfox, NB-IoT, 5G or the like. According to an embodiment, the communication module is a module using a short-range wireless technology standard, in particular Bluetooth, WiFi or the like. According to an embodiment, the communication module is a data exchange interface. According to an embodiment, the external communication module is a terrestrial, satellite gateway, or the like. According to embodiment, the external communication module is a data center.

According to an embodiment, data logger, e.g., having 14 grams of weight, is to be attached to the neck of cats with a regular cat collar. The data logger records, at a certain rate, e.g., the rate of 16 Hz, the acceleration in two or three physical dimensions.

According to an embodiment, an artificial intelligence (AI) algorithm is trained to recognize the difference in hunting behaviour, and is able to detect hunting behaviour for birds with high accuracy. In case of false negative alerts, no harm is done as such alerts simply indicate that a cat is present, even if the cat is not hunting. According to an embodiment, a supervised machine learning approach is used, where the recorded hunting examples are used as annotated training data for the algorithm, which will then replicate the annotation on new (i.e., live) data. When using, e.g., fine-scale 3D-acceleration data, recorded at high frequencies and high resolutions, the algorithm learns and detects decision boundaries based on the smallest of movements.

The present solution also relates to a device for animal behaviour modulation of at least one first animal attached to the body of a second animal, wherein the device comprises a memory, at least one sensor, a processor, and a signal generator, and is configured to:

store, in the memory, at least one extracted characteristic feature of training data of at least one monitored physical quantity in at least one degree of freedom in momentum, specific to at least one behaviour of the second animal and/or at least one local environmental condition related to the second animal; monitor, by the at least one sensor, the at least one monitored physical quantity of the second animal and/or the at least one local environmental condition related to the second animal; determine, by the processor, a type of behaviour of the second animal based on the at least one monitored physical quantity of the second animal and/or the at least one local environmental condition related to the second animal, and the stored at least one extracted characteristic feature of the training data; and generate, by the signal generator, a warning signal based on the determining a first set type of behaviour of the second animal, so that the warning signal induces the behaviour modulation of the at least one first animal.

According to an embodiment, the behaviour modulation of the at least one first animal comprises the induction of flight behaviour. According to an embodiment, the flight behaviour comprises running and/or flying. According to an embodiment, behaviour modulation of the at least one first animal comprises the generation of warning sounds by the at least one first animal.

According to an embodiment, the behaviour of the second animal is not modulated. According to an embodiment, the behaviour of the second animal is not modulated, wherein not modulated means that the behaviour of the second animal during the warning sound and/or carrying the device is not different from the behaviour in the absence of the warning sound and/or carrying the device and, in particular, this does not exclude that the second animal shows a reaction to the generated warning signal, wherein said reaction may be but is not limited to a startle response and/or the termination of hunting behaviour. According to an embodiment, the behaviour of the second animal is modulated. According to an embodiment, the behaviour of the second animal is modulated, in particular a startle response and/or termination of hunting behaviour is induced. According to an embodiment, the behaviour of the second animal is modulated by the generated warning signal. According to an embodiment, the behaviour of the second animal is modulated by conditioning, in particular operant/instrumental conditioning. According to an embodiment, the behaviour of the second animal is modulated by a stimulus applied to the second animal. According to an embodiment, the stimulus applied to the second animal is an adverse stimulus. According to an embodiment, the adverse stimulus is a sound, in particular a sound that is specifically audible to the second animal. According to an embodiment, the adverse stimulus applied to the second animal is an electric shock, in particular a foot shock.

According to an embodiment, the at least one first animal is prey. According to an embodiment, the at least one first animal is a bird, rodent, amphibia and/or an insect. In an embodiment, the at least one first animal is a bird. In an embodiment, the at least one first animal is a passerine. In an embodiment, the at least one first animal is a songbird. According to an embodiment, the at least one first animal is a rodent. According to an embodiment, the at least one first animal is a mouse, a rat, a hamster and/or a squirrel. According to an embodiment, the at least one first animal is an insect.

According to an embodiment, the second animal is a predator. According to an embodiment, the second animal belongs to the biological order of Carnivora. According to an embodiment, the second animal is a felid. According to an embodiment, the second animal is a feline. According to an embodiment, the second animal belongs to the biological genus Felis. According to an embodiment, the second animal is a domestic cat (Felis catus).

According to an embodiment, the at least one sensor monitoring the at least one motion parameter of the second animal comprises or is a Micro-Electro-Mechanical Systems, MEMS, in particular an inertial measurement unit, IMU, a magnetometer, a microphone, and/or a pressure sensor. According to an embodiment, the inertial measurement unit comprises or is an accelerometer.

According to an embodiment, the at least one sensor monitors the forces exerted on the sensors.

According to an embodiment, the monitored at least one motion parameter is an acceleration in x,y, and z direction in Euclidean space.

According to an embodiment, the value of the at least one motion parameter is determined by the motion of the device attached to the second animal along the vertical (yaw), transverse (pitch) and/or longitudinal axis (roll).

According to an embodiment, the at least one local environmental condition comprises or is a pressure, a humidity, a sound pressure in the vicinity of the second animal and/or the position of the animal as determined by GPS.

According to an embodiment, the values assigned to the at least one monitored physical quantity in at least one degree of freedom in momentum may be in any form, in particular analog and/or digital, and is induced by the physical movements of the second animal to which the device is attached. According to an embodiment, a sensor or a plurality of sensors monitor at least one monitored physical quantity and/or at least one environmental condition related to the second animal over a set range of period or an indefinite period of time and the values assigned to the at least one physical quantity and/or the at least environmental condition form training data. According to an embodiment, the values assigned to the at least one monitored physical quantity is communicated externally from the communication module to the external communication module. According to an embodiment, the values assigned to the at least one monitored physical quantity and/or the at least one environmental condition is pre-processed, in particular truncated and/or filtered in time-domain and/or frequency domain. According to an embodiment, the values assigned to the at least one monitored physical quantity or the pre-processed data are extracted to characteristic features, then categorized or classified into different behaviour motions of the second animal by humans, in particular by examining the at least one extracted characteristic features or the pre-processed data. According to an embodiment, the categorization or classification is conducted by humans by examining the at least one physical quantity in conjunction and/or the at least one local environment in conjunction with another monitored data, in particular a video of behaviour motions of the second animal temporally corresponding to the values assigned to the at least one monitored physical quantity and/or the at least one local environment and assigning behavioural classes and/or extracting at least one characteristic feature. According to an embodiment, the classification or categorization is performed by the processor, in particular machine learning algorithm automatically. According to an embodiment, the values assigned to at least one monitored physical quantity and/or pre-processed data and/or categorized data is part of or is the at least one extracted characteristic feature of training data stored in the memory. According to an embodiment, the first set type of behaviour of the second animal is a hunting behaviour. According to an embodiment, the first set type of behaviour of the second animal is hunting behaviour for a specific animal. According to an embodiment, the first set type of behaviour of the second animal is hunting an animal selected from the group consisting of birds, rodents, amphibia and insects. In an embodiment, the first set type of behaviour of the second animal is hunting a bird. In an embodiment, the first set type of behaviour of the second animal is hunting a passerine. In an even preferred embodiment, the first set type of behaviour of the second animal is hunting a songbird. According to an embodiment, the first set type of behaviour of the second animal is hunting a rodent. According to an embodiment, the first set type of behaviour of the second animal is hunting a rodent, wherein the rodent is a mouse, a rat, a hamster and/or a squirrel. According to an embodiment, the first set type of behaviour of the second animal is hunting an insect.

According to an embodiment, the warning signal is not generated based on a determined second set type of behaviour of the second animal. According to an embodiment, the second set type of behaviour of the second animal is different form the first set type of behaviour. According to an embodiment, the second set type of behaviour of the second animal is a specific hunting behaviour. According to an embodiment, the second set type of behaviour of the second animal is hunting a rodent. According to an embodiment, the second set type of behaviour of the second animal is hunting a rodent, wherein the rodent is a mouse, a rat, a hamster and/or a squirrel.

According to an embodiment, the warning signal is not generated based on a determined local environmental condition, in particular, a specific position of the second animal. According to an embodiment, the warning signal is only generated based on a determined set type of behaviour of the second animal and a simultaneously determined local environmental condition.

According to an embodiment, the warning signal is a sound that is at least audible to the at least one first animal. According to an embodiment, the warning signal is a sound, wherein the sound has frequency of 50 Hz to 12 kHz. According to an embodiment, the warning signal is a sound, wherein the sound has a frequency of 1 to 5 kHz. According to an embodiment, warning signal is a non-naturally occurring sound. According to an embodiment, the non-naturally occurring sound has a constant frequency or comprises a plurality of different frequencies. According to an embodiment, the warning signal mimics a naturally occurring warning sound. According to an embodiment, the warning signal mimics a naturally occurring warning sound of birds. According to an embodiment, the mimicked naturally occurring warning sound of birds is a ground-specific warning sound. According to an embodiment, the mimicked naturally occurring warning sound of birds is an air-specific warning sound. According to an embodiment, the mimicked naturally occurring warning sound is the alarm call of the male Red-winged Blackbirds (Agelaius phoeniceus).

According to an embodiment, the signal generator comprises or is a piezoelectric transducer.

According to an embodiment, the training data comprises values of the monitored at least one parameter induced by the motion of the second animal.

According to an embodiment, the animal behaviour modulation device is a necklace, a housing or the like. According to an embodiment, the animal behaviour modulation device is attached to a necklace. According to an embodiment, the animal behaviour modulation device is located inside a necklace. According to an embodiment, the device is implanted under the skin of the second animal.

According to an embodiment, the at least one sensor comprises a processor that is not the processor of the device. According to an embodiment, the at least one sensor or the processor in the at least one sensor comprises a memory to store the at least one extracted characteristic feature of training data, in particular a non-volatile memory including a flash memory, read-only memory, random access memory, and/or the like. According to an embodiment, the processor in the at least one sensor communicates, bidirectionally, with the processor of the device, other processors in other sensors, and memory of the device. According to an embodiment, the communication comprises information pertaining to available computational resources and storage. According to an embodiment, the processor in the at least one sensor processes the at least one monitored physical quantity and/or local environmental condition and extracts the at least one characteristic feature. According to an embodiment, the at least one sensor comprises a processor and the device has a processor, wherein the processor in the at least one sensor is not the same as the processor of the device. Such embodiment is favourable in that the computational load can be balanced among the plurality of processors and reduces data exchange rate, which in turn reduces power consumption and heat dissipation.

According to an embodiment, the processor of the device is the only processor. According to an embodiment, the processor in the device is part of system in a package. According to an embodiment, the processor in the device is a processor produced on a separate chip than the chip of the device. Such embodiment is favourable in that the processor is computationally powerful.

According to an embodiment, the at least one extracted characteristic feature of training data is a processed parameter based on the at least one monitored physical quantity in at least one degree of freedom in momentum, specific to at least one behaviour of the second animal and/or at least one local environmental condition related to the second animal, in particular standard deviation, skewness, kurtosis, value range, maximum value, minimum value, dominant frequency, mean crossing rate, zero crossing rate, and/or the like.

According to an embodiment, the processor discriminates the first set type of behaviour from the second set type of behaviour, in particular machine learning algorithm classifies the monitored at least one monitored physical quantity and/or the at least one local environmental condition based on the stored at least one extracted characteristic feature, more particularly by using statistical classification algorithms including K-Nearest Neighbours, decision tree, and support vector machine.

According to an embodiment, the classified or categorized motions of the second animal or a plurality of classified or categorized motions of the second animal represent the first set type of behaviour corresponding to hunting the first animal, e.g. a songbird or the second set type of behaviour corresponding to hunting an animal different from the first animal, e.g. a mouse or a third set type of behaviour that is not the first and the second set type of behaviours. According to an embodiment, the number of sets of behaviour is not limited. According to an embodiment, the processor determines the behaviour of the second animal based on the classified or categorized motions of the second animal or the plurality of classified or categorized motions the second animal and feeds the control signal to the piezoelectric transducer which may or may not generate a warning signal.

According to an embodiment, the animal behaviour modulation device is a necklace, a housing or the like. According to an embodiment, the animal behaviour modulation device is attached to a necklace. According to an embodiment, the animal behaviour modulation device is located inside a necklace. According to an embodiment, the device implanted under the skin of the second animal.

According to an embodiment, the communication module is a wireless or wired communication network. According to an embodiment, the communication module exchanges information with the external communication module unidirectionally or bidirectionally. According to an embodiment, the communication module is a long-range telemetry module in particular, a long range module (LoRA), Sigfox, NB-IoT, 5G or the like. According to an embodiment, the communication module is a module using a short-range wireless technology standard, in particular Bluetooth, WiFi or the like. According to an embodiment, the communication module is a data exchange interface. According to an embodiment, the external communication module is a terrestrial, satellite gateway, or the like. According to embodiment, the external communication module is a data center.

According to an embodiment, data logger, e.g., having 14 grams of weight, is to be attached to the neck of cats with a regular cat collar. The data logger records, at a certain rate, e.g., the rate of 16 Hz, the acceleration in two or three physical dimensions.

According to an embodiment, an artificial intelligence (AI) algorithm is trained to recognize the difference in hunting behaviour, and is able to detect hunting behaviour for birds with high accuracy. In case of false negative alerts, no harm is done as such alerts simply indicate that a cat is present, even if the cat is not hunting. According to an embodiment, a supervised machine learning approach is used, where the recorded hunting examples are used as annotated training data for the algorithm, which will then replicate the annotation on new (i.e., live) data. When using, e.g., fine-scale 3D-acceleration data, recorded at high frequencies and high resolutions, the algorithm learns and detects decision boundaries based on the smallest of movements.

### Active Modulation of Animal Behaviour

The device attached to the second animal may further be used to actively modulate the behaviour of the second animal. According to an embodiment, the device attached to the second animal further comprises a receiver, wherein the receiver is used to receive the wirelessly transmitted signal from a device, in particular the mobile phone of the cat owner. According to an embodiment, the wirelessly transmitted signal is based on the Bluetooth LE and/or WiFi technology.

### Location-Based Animal Behaviour Modulation

The device attached to the second animal may be further used to prevent the second animal from entering and/or leaving a certain area and/or preventing an animal from exhibiting a certain behaviour within said area.

According to an embodiment, the device attached to the second animal is further comprised in a system together with at one communication device, the device is configured to communicate data wirelessly between the device attached to the second animal and the at least one communication device; to determine the distance between the device attached to second animal and the at least one communication device based on the communicated data; to determine, by the processor of the device attached to the second animal, a type of behaviour of the second animal, to generate a stimulus when the distance exceeds a pre-set boundary and/or a set type of behaviour is determined; and to modulate, via the generated stimulus, the behaviour of the second animal.

According to an embodiment, the stimulus is generated, by the at least one communication device and/or the device attached to the animal, by determining a distance below a set threshold distance between the device attached to the animal and the at least one communication device.

According to an embodiment, the processor is further configured to: identify, via GPS, the position of the animal; and generate, by the device attached to the animal, a stimulus based on determining a set position of the animal.

According to an embodiment, the set type of behaviour is scratching on an object, in particular furniture, defecation behaviour and/or hunting behaviour.

According to an embodiment, the generated stimulus is an adverse stimulus.

According to an embodiment, the adverse stimulus is a sound and/or an electric shock.

According to an embodiment, the intensity of the generated stimulus increases with decreasing distance to the communication device and/or set position; and/or with increasing time at a distance below a set threshold distance to the communication device and/or at the set position.

According to an embodiment, the device is configured to modulate the behaviour of the animal in particular by performing modulating the animal to increase the distance of the animal to the communication device and/or the set position.

According to an embodiment, the generated stimulus conditions the animal to avoid the communication device, the set position and/or the set type of behaviour.

According to an embodiment, the generated stimulus is a stimulus to which the animal is conditioned/trained to exhibit a specific behaviour, in particular returning to their home. According to an embodiment, the stimulus is a clicker sound.

According to an embodiment, the stimulus that modulates the behaviour of the second animal conditions the second animal to avoid the specific object and/or location. According to an embodiment, the signal is generated by manual activation, in particular via wireless communication, of the device attached to the animal and/or the communication device.

The present disclosure also relates to a system for modulating the behaviour of an animal to be carried out on the system comprising a device attached to the animal and at least one communication device, the system comprising the device according to any one of the above-described embodiments and the at least one communication device.

### Determination of the Health-Status

The device attached to the second animal may be further used to determine the health status of the second animal. According to an embodiment, the device is further configured to store, in the memory, at least one extracted characteristic feature of training data of at least one monitored physical quantity in at least one degree of freedom in momentum, specific to at least one health-related behaviour of the second animal and/or at least one local environmental condition related to the second animal; monitor, by the at least one sensor, the at least one monitored physical quantity of the second animal and/or the at least one local environmental condition related to the second animal; determine, by the processor, a type of health-related behaviour of the second animal based on the at least one monitored physical quantity of the second animal and/or the at least one local environmental condition related to the second animal, and the stored at least one extracted characteristic feature of the training data; and identifying, by the processor, the health status of the second animal based on the determined type of health-related behaviour of the second animal.

According to an embodiment, the processor is further configured to identifying the health status of the second animal by performing, in particular comprises or is, by the processor, determining when the determined type of the health-related behaviour corresponds to a set type of health-related behaviour, whether the determined type of health-related behaviour is indicative of a normal health status or an abnormal health status, in particular by comparing at least one parameter related to the determined type of health-related behaviour to a reference value.

According to an embodiment, the set type of health-related behaviour comprises or is drinking, scratching, interest in the anorectal region, defecation, coughing, or grooming.

According to an embodiment, the processor is being configured to identify the health status of the animal, in particular by performing:

Determining that the determined type of health-related behaviour is indicative of an abnormal health status when the determined type of health-related behaviour corresponds to a set type of health-related behaviour specific for an abnormal health status indicated by the stored at least one characteristic feature.

According to an embodiment, the at least one parameter is a frequency of occurrence and/or duration of the determined type of health-related behaviour, a magnitude of the at least one monitored physical quantity, and/or a waveform of the at least one monitored physical quantity.

According to an embodiment, the reference value is a range of values and is based on the average at least one parameter specific to the at least one health-related behaviour of the individual second animal and/or a population of individuals of the same species of the second animal.

According to an embodiment, the at least one health-related set type of behaviour is drinking behaviour. According to an embodiment, the at least one health-related set type of behaviour is scratching behaviour. According to an embodiment, the at least one health-related set type of behaviour is the interest in the anorectal region. According to an embodiment, the at least one health-related set type of behaviour is defection behaviour. According to an embodiment, the at least one health-related set type of behaviour is coughing. According to an embodiment, the at least one health-related set type of behaviour is grooming, in particular excessive grooming.

According to an embodiment, the identified abnormal health status is a renal insufficiency, flea infestations, worm infestations and/or filled anal glands, and/or gastric- and intestinal problems.

According to an embodiment, the processor is further configured to identify the renal insufficiency in particular based on performing determining drinking behaviour specific for renal insufficiency, and/or a difference of the determined drinking behaviour compared to the reference value, in particular, increased frequency and/or duration of the drinking behaviour.

According to an embodiment, the processor is further configured to identify the worm infestations and/or filled anal glands in particular based on performing determining an interest in the anorectal region specific for worm infestations and/or filled anal glands, and/or a difference of the determined interest in the anorectal region compared to the reference value, in particular, increased frequency and/or duration of the in the anorectal region.

According to an embodiment, the processor is further configured to identify gastric- and intestinal problems in particular based on performing determining a defecation behaviour specific for gastric- and intestinal problems and/or a difference of the determined defecation behaviour compared to the reference value, in particular, increased or reduced frequency and/or duration of the defecation behaviour.

According to an embodiment, the memory is further configured to store at least one characteristic feature of the determined behaviours.

According to an embodiment, the device is further configured to generate a stimulus, by the device attached to the animal, wherein the stimulus is a stimulus to which the animal is conditioned to exhibit a specific behaviour.

According to an embodiment, the stimulus is generated by manual activation of the device attached to the animal, in particular via wireless communication, is generated by determining a set type of health-related behaviour and/or is generated by identifying a set type of health status.

The number of diseases to be identified is not particularly limited.

According to an embodiment, the device is further configured to send a warning message, in particular to a person responsible for the animal and/or a veterinarian. According to an embodiment, the warning message is an acoustic warning message is generated by a Piezo speaker comprised in the device. According to an embodiment, the warming message is a wirelessly transmitted digital warning message sent via including, but not limited to, LPWAN technologies such as LoRa, Sigfox, WiFi, or Bluetooth LE.

According to an embodiment, the device is further configured to generate a stimulus, by the device attached to the animal, wherein the stimulus is a stimulus to which the animal is conditioned to exhibit a specific behaviour.

According to an embodiment, the stimulus is generated by manual activation of the device attached to the second animal, in particular via wireless communication, is generated by determining a set type of health-related behaviour and/or is generated by identifying a set type of health status.

According to an embodiment, the specific behaviour is moving to a specific position, in particular the home of the second animal.

According to an embodiment, the stimulus is a clicker sound.

The present solution also relates to a system for identifying a health status of an animal to be carried out on a device attached to the animal, the system comprising the device according to any one of the above-described embodiments.

### Definitions

As used herein, “felid” refers to a member of the biological family of Felidae.

As used herein, “feline” refers to a member of the biological family of Felinae.

As used herein, “passerine” refers to a member of the biological order of Passeriformes.

As used herein, “songbird” refers to a member of the biological clade of Passeri.

As used herein, “behaviour of the second animal is not modulated” means that the behaviour of the second animal during the warning sound and/or carrying the device is not different from the behaviour in the absence of the warning sound and/or carrying the device. However, this does not exclude that the second animal shows a reaction to the generated warning signal. Such a reaction may be but is not limited to a startle response and/or the termination of hunting behaviour.

As used herein, “flight behaviour” refers to the behaviour of an animal to escape from (potentially) dangerous situation and/or a (potential) predator.

As used herein, “a ground-specific warning sound” is a warning sound that is generated by birds to warn about a danger or predator on the ground.

As used herein, “an air-specific warning sound” is a warning sound that is generated by birds to warn about a danger or predator in the air.

As used herein, “non-naturally occurring sound” refers to sounds that are not generated by animals or otherwise found in nature.

As uses herein, “conditioning” refers to adapting of behaviour to a known signal/stimulus, in particular the warning signal. A non-limiting example of such conditioning is operant/instrumental conditioning, wherein an animal learned that a specific behaviour results in a specific signal/stimulus, e.g., an adverse signal/stimulus, and thus avoids the specific behaviour. In another non-limiting example, a specific behaviour may be promoted by a specific signal/stimulus.

The example embodiments disclosed herein are directed to providing features that will become readily apparent by reference to the following description when taken in conjunction with the accompanying drawings. In accordance with various embodiments, example systems, methods, and devices are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present solution.

Thus, the present solution is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a flowchart according to an embodiment of the present solution.

FIG. 2 illustrates an example device according to an embodiment of the present solution.

FIGS. 3A & 3B illustrate an example animal behaviour modulation according to an embodiment of the present solution.

FIG. 4 to FIG. 9 (subfigures (a) & (b)) illustrate the acceleration measurement using an example device according to an embodiment of the present solution.

FIG. 10 and FIG. 11 illustrate flowcharts of the methods according to embodiments of the present disclosure.

FIGS. 12A-12B and FIGS. 13A-13B illustrate devices and systems according to embodiments of the present disclosure.

### DETAILED DESCRIPTION

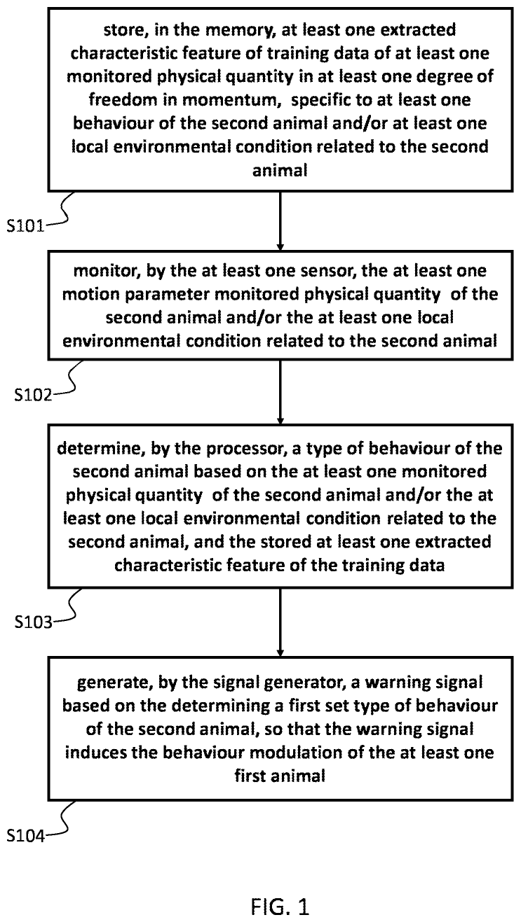

FIG. 1 shows a flow chart according to an embodiment of the present solution.

In S101, a device for animal behaviour modulation stores at least one extracted characteristic feature of training data of at least one monitored physical quantity in at least one degree of freedom in momentum, specific to at least one behaviour of the second animal and/or at least one local environmental condition related to the second animal in a memory. The at least one extracted characteristic feature of the training data relates to at least one motion parameter of the second animal.

In S102, at least one sensor is configured to monitor the at least one monitored physical quantity of the second animal and/or the at least one local environmental condition related to the second animal.

In S103, a processor is configured to determine a type of behaviour of the second animal based on the at least one monitored physical quantity of the second animal and/or the at least one local environmental condition related to the second animal and the stored at least one extracted characteristic feature of the training data.

In S104, a signal generator, e.g., a sound generator, is configured to generate a warning signal based on the determining a first set type of behaviour of the second animal, so that the warning signal induces the behaviour modulation of the at least one first animal.

According to an embodiment, the behaviour of the second animal is not modulated. Not modulating the behaviour of the second animal is preferred when the second animal, for example a domestic cat, should not be disturbed in their general natural behaviour. This is especially wanted when generating a warning sound and the corresponding behaviour modulation of the at least first animal, for example a songbird, results in the wanted result, i.e., saving the songbird from being killed by the cat. According to an embodiment, the behaviour of the second animal is not modulated, wherein not modulated means that the behaviour of the second animal during the warning sound and/or carrying the device is not different from the behaviour in the absence of the warning sound and/or carrying the device and, in particular, this does not exclude that the second animal shows a reaction to the generated warning signal, wherein said reaction may be but is not limited to a startle response and/or the termination of hunting behaviour. However, it is also conceivable that the modulation of the behaviour of the second animal, for example a domestic cat, may be of interest by their owners. In particular, the present solution may thus also be used for modulating the behaviour of the second animal over time. This might be advantageous when the second animal, for example a domestic cat, avoids the first set type of behaviour, for example hunting a songbird, which results in the generation of the warning sound. Accordingly, the present solution can also be used to prevent the at least one first animal, for example a songbird from being killed by the second animal, for example a domestic cat, by modulating the behaviour of said second animal. According to an embodiment, the behaviour of the second animal is modulated. According to an embodiment, the behaviour of the second animal is modulated, in particular a startle response and/or termination of hunting behaviour is induced. According to an embodiment, the behaviour of the second animal is modulated by the generated warning signal. According to an embodiment, the behaviour of the second animal is modulated by conditioning, in particular operant/instrumental conditioning. According to an embodiment, the behaviour of the second animal is modulated by a stimulus applied to the second animal. According to an embodiment, the stimulus applied to the second animal is an adverse stimulus. According to an embodiment, the adverse stimulus is a sound, in particular a sound that is specifically audible to the second animal. According to an embodiment, the adverse stimulus applied to the second animal is an electric shock, in particular a foot shock.

According to an embodiment, the behaviour modulation of the at least one first animal comprises the induction of flight behaviour. According to an embodiment, the flight behaviour comprises running and/or flying. According to an embodiment, behaviour modulation of the at least one first animal comprises the generation of warning sounds by the at least one first animal.

The present solution allows to induce behaviour modulation of a specific animal or group of animals. Accordingly, the present solution can be adjusted to a many different fields of application. For example, in an area with songbirds present it may be preferred that the second animal, for example a domestic cat, is prevented from killing said songbirds. However, killing of rodents may be explicitly desired. The present solution is advantageous in this regard because it can be adjusted accordingly. This is also very advantages since the application in different areas, e.g., rural areas versus domestic areas, may has different demands. For example, it may be preferred that rodents, in particular threatened species, e.g., the common hamster, are prevented from being killed by the second animal. Again, as mentioned above, the present solution is thus advantageous because it can be adjusted to a plurality of animals depending on the needs of the field of application. According to an embodiment, the at least one first animal is prey. According to an embodiment, the at least one first animal is a bird, rodent, amphibia and/or an insect. In an embodiment, the at least one first animal is a bird. In one embodiment, the at least one first animal is a passerine. In another embodiment, the at least one first animal is a songbird. According to an embodiment, the at least one first animal is a rodent. According to an embodiment, the at least one first animal is a mouse, a rat, a hamster and/or a squirrel. According to an embodiment, the at least one first animal is an insect.

According to an embodiment, the second animal is a predator. According to an embodiment, the second animal belongs to the biological order of Carnivora. According to an embodiment, the second animal is a felid. According to an embodiment, the second animal is a feline. According to an embodiment, the second animal belongs to the biological genus Felis. According to an embodiment, the second animal is a domestic cat (Felis catus).

According to an embodiment, the at least one sensor monitoring the at least one motion parameter of the second animal comprises or is a Micro-Electro-Mechanical Systems, MEMS, in particular an inertial measurement unit, IMU, a magnetometer, a microphone, and/or a pressure sensor.

According to an embodiment, the inertial measurement unit comprises or is an accelerometer.

According to an embodiment, the at least one sensor monitors the forces exerted on the sensors.

According to an embodiment, the monitored at least one motion parameter is an acceleration in x,y, and z direction in Euclidean space.

According to an embodiment, the value of the at least one motion parameter is determined by the motion of the device attached to the second animal along the vertical (yaw), transverse (pitch) and/or longitudinal axis (roll).

According to an embodiment, the at least one monitored physical quantity is a quantity to which a measured value induced by the motion of the second animal is assigned.

According to an embodiment, the at least one local environmental condition is a quantity to which measured value of local environment is assigned.

According to an embodiment, the at least one local environmental condition comprises or is a pressure, a humidity, a sound pressure in the vicinity of the second animal and/or the position of the animal as determined by GPS.

As mentioned above, the present solution can be adjusted to specific animal, i.e., the behaviour of the second animal that leads to the generation of the warning sound can be adjusted to be a specific behaviour. Accordingly, the present solution allows fine tuning to the needs of the users and/or field of application. According to an embodiment, the first set type of behaviour of the second animal is a hunting behaviour. According to an embodiment, the first set type of behaviour of the second animal is hunting behaviour for a specific animal. According to an embodiment, the first set type of behaviour of the second animal is hunting an animal selected from the group consisting of birds, rodents, amphibia and insects. In an embodiment, the first set type of behaviour of the second animal is hunting a bird. In an embodiment, the first set type of behaviour of the second animal is hunting a passerine. In an embodiment, the first set type of behaviour of the second animal is hunting a songbird. According to an embodiment, the first set type of behaviour of the second animal is hunting a rodent. According to an embodiment, the first set type of behaviour of the second animal is hunting a rodent, wherein the rodent is a mouse, a rat, a hamster and/or a squirrel. According to an embodiment, the first set type of behaviour of the second animal is hunting an insect. The present solution further allows to specifically exclude a behaviour of the second animal to generate a warning sound. This allows further to fine tuning the present solution to the needs of the user and/or field of application. For example, the present solution is able to determine between different behaviours of the second animal. If required, a warning sound can be generated when the second animal, for example a domestic cat, exhibits hunting behaviour for e.g., a songbird and no warning sound is generated when the second animal exhibits hunting behaviour of a rodent. According to an embodiment, the warning signal is not generated based on a determined second set type of behaviour of the second animal. According to an embodiment, the second set type of behaviour of the second animal is different form the first set type of behaviour. According to an embodiment, the second set type of behaviour of the second animal is a specific hunting behaviour. According to an embodiment, the second set type of behaviour of the second animal is hunting a rodent. According to an embodiment, the second set type of behaviour of the second animal is hunting a rodent, wherein the rodent is a mouse, a rat, a hamster and/or a squirrel.

The warning sound for behaviour modulation can also be adjusted to specifically target the at least first animal. This can be achieved by a specific frequency of the generated warning sound that may be only audible to a specific animal. This may be advantageous because it may prevent the second animal from perceiving the warning sound and thus may avoids the behaviour modulation of the second animal, i.e., may not interfere with the natural behaviour of the second animal or other animals in the surroundings. According to an embodiment, the warning signal is a sound that is at least audible to the at least one first animal. According to an embodiment, the warning signal is not generated based on a determined local environmental condition, in particular, a specific position of the second animal. According to an embodiment, the warning signal is only generated based on a determined set type of behaviour of the second animal and a simultaneously determined local environmental condition. According to an embodiment, the warning signal is a sound, wherein the sound has frequency of 50 Hz to 12 kHz. According to an embodiment, the warning signal is a sound, wherein the sound has a frequency of 1 to 5 kHz. According to an embodiment, warning signal is a non-naturally occurring sound. According to an embodiment, the non-naturally occurring sound has a constant frequency or comprises a plurality of different frequencies. According to an embodiment, the warning signal mimics a naturally occurring warning sound. According to an embodiment, the warning signal mimics a naturally occurring warning sound of birds. According to an embodiment, the mimicked naturally occurring warning sound of birds is a ground-specific warning sound. According to an embodiment, the mimicked naturally occurring warning sound of birds is an air-specific warning sound. According to an embodiment, the mimicked naturally occurring warning sound is the alarm call of the male Red-winged Blackbirds (Agelaius phoeniceus).

### Active Modulation of Animal Behaviour

The present solution may also be used to actively modulate the behaviour of the second animal. This can be done by conditioning the second animal to a specific stimulus such that the second animal exhibits a certain behaviour in the presence of said specific stimulus. Such certain behaviour may be returning to the home the second animal.

According to an embodiment, the stimulus applied to the second animal is non-adverse stimulus. According to an embodiment, the non-adverse stimulus is generated, by the signal generator, based on a manual activation, in particular by the cat owner. According to an embodiment, the manual activation of the signal generator is based on a wirelessly received signal from a device, in particular the mobile phone of the cat owner. According to an embodiment, the device attached to the second animal further comprises a receiver, wherein the receiver is used to receive the wirelessly transmitted signal from a device, in particular the mobile phone of the cat owner. According to an embodiment, the wirelessly transmitted signal is based on the Bluetooth LE and/or WiFi technology. According to an embodiment, the non-adverse stimulus is a sound, in particular a clicker sound. According to an embodiment, the non-adverse stimulus is a stimulus to which the second animal is conditioned to exhibit a specific behaviour. According to an embodiment, the specific behaviour to which the second animal is conditioned is moving to a specific location, in particular their home. According to an embodiment, the volume of the non-adverse sound is manually adjustable via the device that transmits the wireless signal. According to an embodiment, the non-adverse sound is used to identify the location of the second animal indoors and/or outdoors.

### Location-Based Animal Behaviour Modulation

The present method may be further used to prevent the second animal from entering and/or leaving a certain area and/or preventing an animal from exhibiting a certain behaviour within said area.

According to an embodiment, the method is carried out on a system comprising the device attached to the second animal and at least one communication device, the method comprises communicating data wirelessly between the device attached to the second animal and the at least one communication device; determining the distance between the device attached to second animal and the at least one communication device based on the communicated data; determining, by the device attached to the second animal, a type of behaviour of the second animal, generating a stimulus when the distance exceeds a preset boundary and/or a set type of behaviour is determined; and modulating, via the generated stimulus, the behaviour of the second animal. According to an embodiment, the stimulus is generated, by the at least one communication device and/or the device attached to the second animal, by determining a distance below a set threshold distance between the device attached to second animal and the at least one communication device. According to an embodiment, the distance of the second animal to the at least one communication device (‘proximity buttons’) is determined based on wirelessly transmitted signals. According to an embodiment, the set type of behaviour is scratching on an object, in particular furniture, defecation behaviour and/or hunting behaviour. According to an embodiment, the method further comprises identifying, via GPS, the position of the animal; and generating, by the device attached to the second animal, a stimulus based on determining a set position of the second animal. According to an embodiment, the stimulus that modulates the behaviour of the second animal is an adverse stimulus. According to an embodiment, the adverse stimulus is a sound and/or an electric shock. According to an embodiment, the intensity of the generated stimulus increases with decreasing distance to the communication device and/or set position; and/or with increasing time at a distance below a set threshold distance to the communication device and/or at the set position. According to an embodiment, modulating the behaviour of the second animal is modulating the second animal to increase the distance to the communication device and/or the set position. According to an embodiment, the generated stimulus is a stimulus to which the second animal is conditioned/trained to exhibit a specific behaviour, in particular returning to their home. According to an embodiment, the stimulus to which the second animal is conditioned/trained is a non-adverse stimulus. According to an embodiment, the non-adverse stimulus is a clicker sound. According to an embodiment, the stimulus that modulates the behaviour of the second animal conditions the second animal to avoid the specific object and/or location. According to an embodiment, the signal is generated by manual activation, in particular via wireless communication, of the device attached to the animal and/or the communication device.

### Determination of the Health-Status

The present method can also be used to identify the health status of the second animal. In this embodiment of the solution, a type of health-related behaviour of the second animal is determined in addition to, for example, hunting behaviour.

According to an embodiment, the method further comprises storing, in the memory, at least one characteristic feature of training data of at least one monitored physical quantity in at least one degree of freedom in momentum, specific to at least one health-related behaviour of the second animal and/or at least one local environmental condition related to the second animal; determining, by the processor, a type of health-related behaviour of the second animal based on the at least one monitored physical quantity of the second animal and/or the at least one local environmental condition related to the second animal, and the stored at least one characteristic feature of the training data; and identifying, by the processor, the health status of the second animal based on the determined type of health-related behaviour of the second animal.

It can be indicative for an abnormal health status when a certain behaviour is exhibited more or less often than normal. For example, it is known that also healthy animals cough from time to time without being critically ill. Yet, extensive coughing may be indicative for a severe illness. Therefore, the present method is able to determine whether the occurrence of a specific health-related behaviour is indicative for a normal or abnormal health status.

According to an embodiment, identifying the health status of the second animal comprises or is determining, by the processor, when the determined type of the health-related behaviour corresponds to a set type of health-related behaviour, whether the determined type of health-related behaviour is indicative of a normal health status or an abnormal health status, in particular by comparing at least one parameter related to the determined type of health-related behaviour to a reference value.

According to an embodiment, the at least one parameter is a frequency of occurrence and/or duration of the determined type of health-related behaviour, a magnitude of the at least one monitored physical quantity, and/or a waveform of the at least one monitored physical quantity.

According to an embodiment, the reference value is a range of values and is based on the average at least one parameter specific to the at least one health-related behaviour of the individual second animal and/or a population of individuals of the same species of the second animal.

According to an embodiment, the at least one health-related set type of behaviour is drinking behaviour. According to an embodiment, the at least one health-related set type of behaviour is scratching behaviour. According to an embodiment, the at least one health-related set type of behaviour is the interest in the anorectal region. According to an embodiment, the at least one health-related set type of behaviour is defection behaviour. According to an embodiment, the at least one health-related set type of behaviour is coughing. According to an embodiment, the at least one health-related set type of behaviour is grooming, in particular excessive grooming.

Another way of the solution to identify an abnormal health status of an animal is to determine a specific health-related type of behaviour that is only observed during illness. According to an embodiment, identifying the health status of the second animal further comprises determining, by the processor, that the determined type of health-related behaviour is indicative of an abnormal health status when the determined type of health-related behaviour corresponds to a set type of health-related behaviour specific for an abnormal health status indicated by the stored at least one characteristic feature.

The number of diseases to be identified is not particularly limited.

According to an embodiment, the identified abnormal health status is a renal insufficiency, flea infestations, worm infestations and/or filled anal glands, and/or gastric- and intestinal problems.

According to an embodiment, the identifying the renal insufficiency is based on determining a drinking behaviour specific for renal insufficiency and/or a difference of the determined drinking behaviour compared to the reference value, in particular, increased frequency and/or duration of drinking behaviour.

According to an embodiment, the identifying the worm infestations and/or filled anal glands is based on determining an interest in the anorectal region specific for worm infestations and/or filled anal glands, and/or a difference of the determined interest in the anorectal region compared to the reference value, in particular, increased frequency and/or duration of the in the anorectal region.

According to an embodiment, the identifying gastric- and intestinal problems is based on determining a defecation behaviour specific for gastric- and intestinal problems and/or a difference of the determined defecation behaviour compared to the reference value, in particular, increased or reduced frequency and/or duration of the defecation behaviour.

According to an embodiment, the method further comprises sending a warning message, in particular to a person responsible for the animal and/or a veterinarian.

According to an embodiment, the method further comprises generating a stimulus, by the device attached to the second animal, wherein the stimulus is a stimulus to which the animal is conditioned to exhibit a specific behaviour.

According to an embodiment, the stimulus is generated by manual activation of the device attached to the second animal, in particular via wireless communication, is generated by determining a set type of health-related behaviour and/or is generated by identifying a set type of health status.

According to an embodiment, the specific behaviour is moving to a specific position, in particular the home of the second animal.

According to an embodiment, the stimulus is a clicker sound.

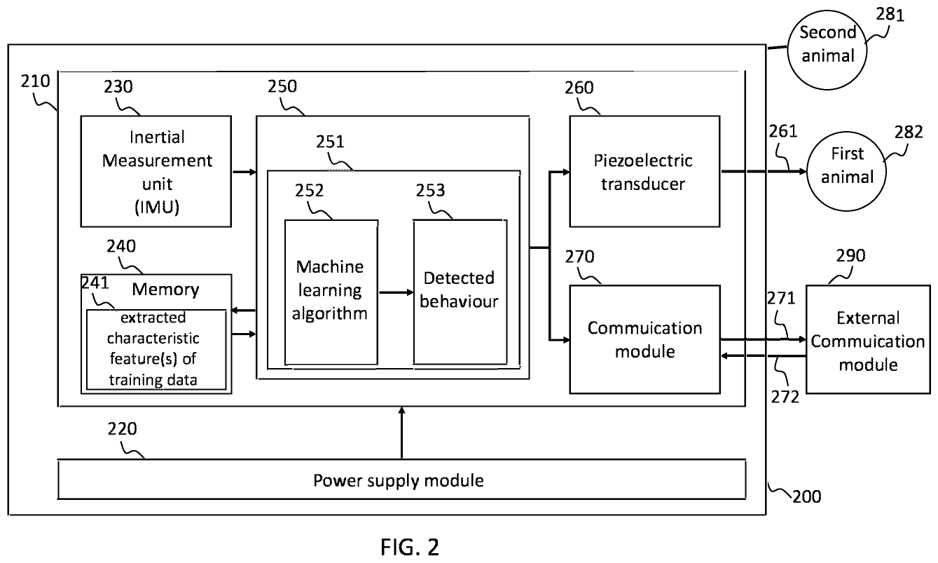

FIG. 2 illustrates an example device according to an embodiment of the present solution.

An animal behavior modulation device 200 comprises a circuit board 210 and a power supply module 220. The power supply module 220 supplies required power to the circuit board 210. The animal behavior modulation device 200 is attached to a second animal 281. The circuit board 210 comprises an inertial measurement unit 230, a memory 240, a processor 250, a piezoelectric transducer 260, a communication module 270. The inertial measurement unit 230 monitors at least one monitored physical quantity in at least one degree of freedom in momentum induced by the motion of the second animal 281 to which the device 200 is attached and/or at least one local environmental condition related to the second animal, and feeds the values of the at least one monitored physical quantity to the processor 250. The memory 240 comprises at least one extracted characteristic feature of training data 241. The memory 240 is interfaced with the processor 250 to exchange the data either unidirectionally or bidirectionally. The processor 250 comprises an embedded software 251 comprising machine learning algorithm 252 and detected behavior 253. The processor 250 determines a type of behavior of the second animal 281 based on the at least one monitored physical quantity of the second animal 281 and/or the at least one local environmental condition and the stored at least one extracted characteristic feature of the training data 241. The processor 250 determines control actions and feeds the control signal to the piezoelectric transducer 260 and/or to communication module 270. The piezoelectric transducer 260 generates a warning signal 261 based on the determining a type of behavior of the second animal, so that the warning signal 261 induces the behavior modulation of the first animal 282. The communication module 270 generates a communication signal 271 to communicate information 271 & 272 to an external communication module 290.

According to an embodiment, the at least one sensor comprises a processor that is not the processor of the device. According to an embodiment, the at least one sensor or the processor in the at least one sensor comprises a memory to store the at least one extracted characteristic feature of training data, in particular a non-volatile memory including a flash memory, read-only memory, random access memory, and/or the like. According to an embodiment, the processor in the at least one sensor communicates, bidirectionally, with the processor of the device, other processors in other sensors, and memory of the device. According to an embodiment, the communication comprises information pertaining to available computational resources and storage. According to an embodiment, the processor in the at least one sensor processes the at least one monitored physical quantity and/or local environmental condition and extracts the at least one characteristic feature. According to an embodiment, the at least one sensor comprises a processor and the device has a processor, wherein the processor in the at least one sensor is not the same as the processor of the device. Such embodiment is favourable in that the computational load can be balanced among the plurality of processors and reduces data exchange rate, which in turn reduces power consumption and heat dissipation.

According to an embodiment, the processor of the device is the only processor. According to an embodiment, the processor in the device is part of system in a package. According to an embodiment, the processor in the device is a processor produced on a separate chip than the chip of the device. Such embodiment is favourable in that the processor is computationally powerful.

According to an embodiment, the at least one extracted characteristic feature of training data is a processed parameter based on the at least one monitored physical quantity in at least one degree of freedom in momentum, specific to at least one behaviour of the second animal and/or at least one local environmental condition related to the second animal, in particular standard deviation, skewness, kurtosis, value range, maximum value, minimum value, dominant frequency, mean crossing rate, zero crossing rate, and/or the like.

According to an embodiment, the behaviour of the second animal is determined by the person skilled in the art, in particular a behavioural biologist and/or a veterinarian. According to an embodiment, the at least one behaviour of the second animal comprises a specific pattern of motions. Non-limiting examples of the at least of behaviour of the second animal are hunting, running, grooming, walking, sleeping, or the like. In an embodiment, hunting behaviour of the domestic cat is specific for a specific type of prey. According to an embodiment, the training data obtained for a specific species, in particular a domestic cat, can be used for determining a type of behaviour of a different species, in particular members of the same biological family, in particular felids.

According to an embodiment, the animal behaviour modulation device 200 is a necklace, a housing or the like. According to an embodiment, the animal behaviour modulation device is attached to a necklace. According to an embodiment, the animal behaviour modulation device is located inside a necklace. According to an embodiment, the device implanted under the skin of the second animal.

According to an embodiment, the power supply module 220 is rechargeable, in particular a Lithium polymer battery. According to an embodiment, the power supply module 220 is an external module capable of supplying the required power to the device 200.

According to an embodiment, the machine learning algorithm 252 is at least one self-learning algorithm. According to an embodiment, training of the at least one self-learning algorithm comprises processing the monitored at least one parameter and/or at least one pre-processed data to determine at least two clusters representative of the behaviours of the second animal. According to an embodiment, the values of the monitored at least one parameter that are used to determine the type of behaviour are stored in the memory 240, in particular as a part of the training data 241.

According to an embodiment, the communication module 270 is a wireless or wired communication network. According to an embodiment, the communication module 270 exchanges information with the external communication module 290 unidirectionally or bidirectionally. According to an embodiment, the communication module 270 is a long-range telemetry module in particular, a long range module (LoRA), Sigfox, NB-IoT, 5G or the like. According to an embodiment, the communication module 270 is a module using a short-range wireless technology standard, in particular Bluetooth, WiFi or the like. According to an embodiment, the communication module 270 is a data exchange interface. According to an embodiment, the external communication module 290 is a terrestrial, satellite gateway, or the like. According to embodiment, the external communication module 290 is a data center.

According to an embodiment, the values assigned to the at least one monitored physical quantity in at least one degree of freedom in momentum may be in any form, in particular analog and/or digital, and is induced by the physical movements of the second animal to which the device 200 is attached. According to an embodiment, a sensor or a plurality of sensors 230 monitor the at least one monitored physical quantity and/or the at least one environmental condition related to the second animal over a set range of period or an indefinite period of time and the values assigned to the at least one monitored physical quantity and/or local environmental condition form training data. According to an embodiment, the values assigned to the at least one monitored physical quantity and/or the at least one environmental condition is communicated externally from the communication module 270 to the external communication module 290 via the processor 250. According to an embodiment, the values assigned to the at least one monitored physical quantity and/or the at least one local environmental condition is pre-processed, in particular truncated and/or filtered in time-domain and/or frequency domain. According to an embodiment, the values assigned to the at least one monitored physical quantity and/or the at least one local environmental condition or the pre-processed data are categorized or classified into different behaviour motions of the second animal by humans, in particular by examining the at least one extracted feature or the pre-processed data. According to an embodiment, the categorization or classification is conducted by humans by examining the at least one physical quantity in conjunction and/or the at least one local environment in conjunction with another monitored data, in particular a video of behaviour motions of the second animal 281 temporally corresponding to the values assigned to the at least one monitored physical quantity and/or the at least one local environment and assigning behavioural classes and/or extracting at least one characteristic feature. According to an embodiment, the classification or categorization is performed by the processor 250, in particular machine learning algorithm 252 automatically. According to an embodiment, the values assigned to at least one monitored physical quantity and/or pre-processed data and/or categorized data is part of or is the at least one extracted characteristic feature of training data 241 stored in the memory.

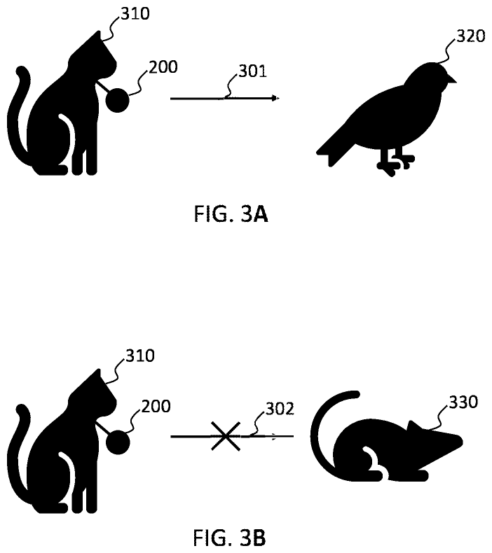

FIG. 3 illustrates an example animal behavior modulation according to an embodiment of the present solution.

In FIG. 3a, a behavior modulation device 200 is attached to a second animal 310, e.g., a cat. The behavior modulation device performs the steps S101˜S104 shown in FIG. 1 and generates a warning signal 301. The warning signal 301 modulates the behavior of the first animal 320, e.g., a songbird.

In FIG. 3b, a behavior modulation device 200 is attached to a second animal 310, e.g., a cat. The behavior modulation device performs the steps S101˜S103 shown in FIG. 1 and does not generate a warning signal 302. The non-generated warning signal 302 does not modulate the behavior of the first animal 330, e.g., a mouse.

According to an embodiment, the processor 250 discriminates the first set type of behaviour from the second set type of behaviour, in particular machine learning algorithm 252 classifies the at least one monitored physical quantity and/or the at least one local environmental condition based on the stored at least one extracted characteristic feature, more particularly by using statistical classification algorithms including K-Nearest Neighbours, decision tree, and support vector machine. According to an embodiment, the classified or categorized motions of the second animal 310 or a plurality of classified or categorized motions of the second animal 310 represent the first set type of behaviour corresponding to hunting the first animal 320, e.g., a songbird or the second set type of behaviour corresponding to hunting an animal 330 different from the first animal 320, e.g., a mouse or a third set type of behaviour that is not the first and the second set type of behaviours. According to an embodiment, the processor 250 determines the behaviour of the second animal 310 based on the classified or categorized motions of the second animal 310 or the plurality of classified or categorized motions the second animal 310 and feeds the control signal to the piezoelectric transducer 260 which may or may not generate a warning signal 301 and 302.

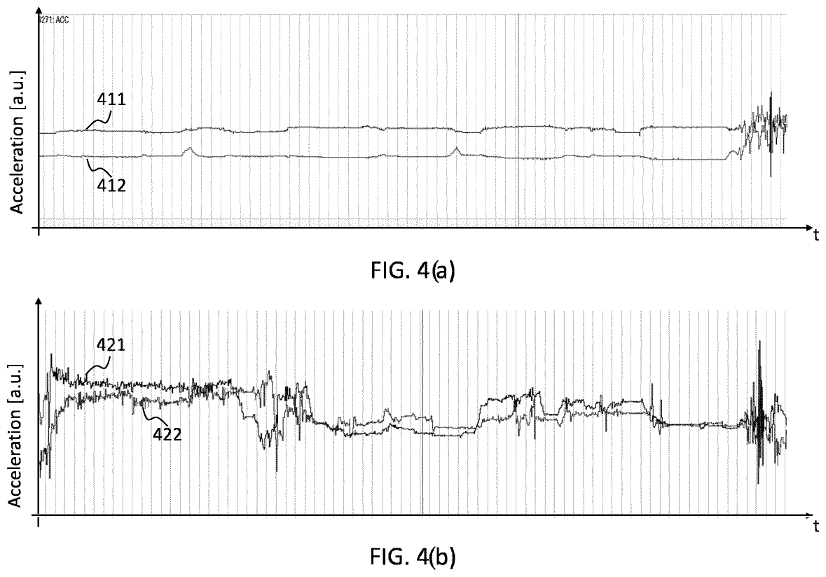

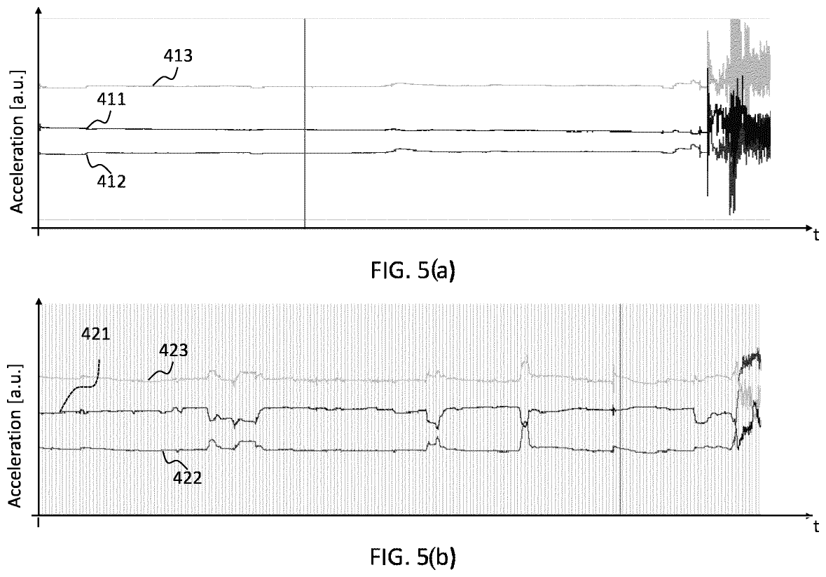

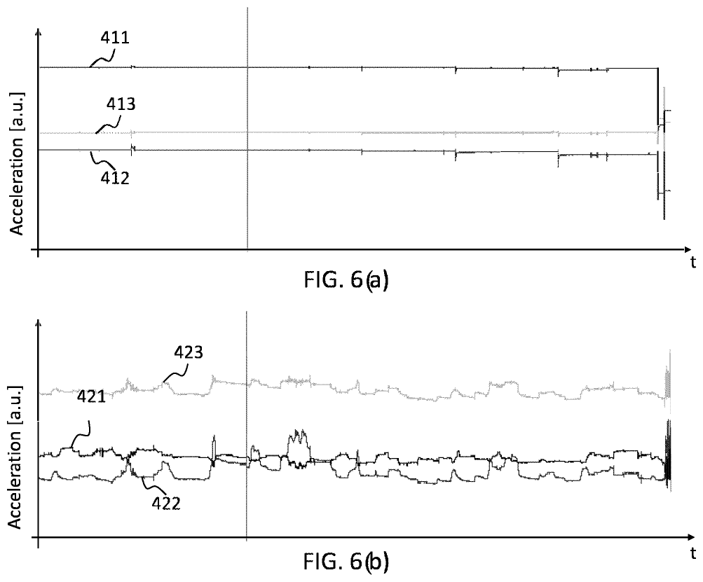

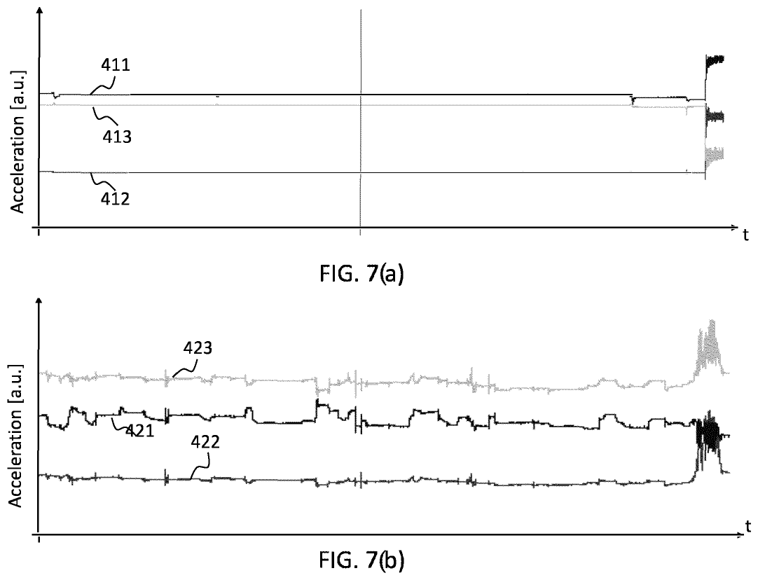

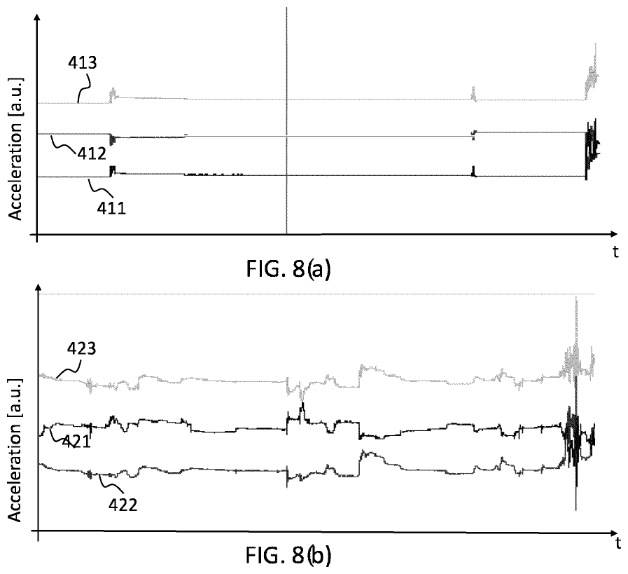

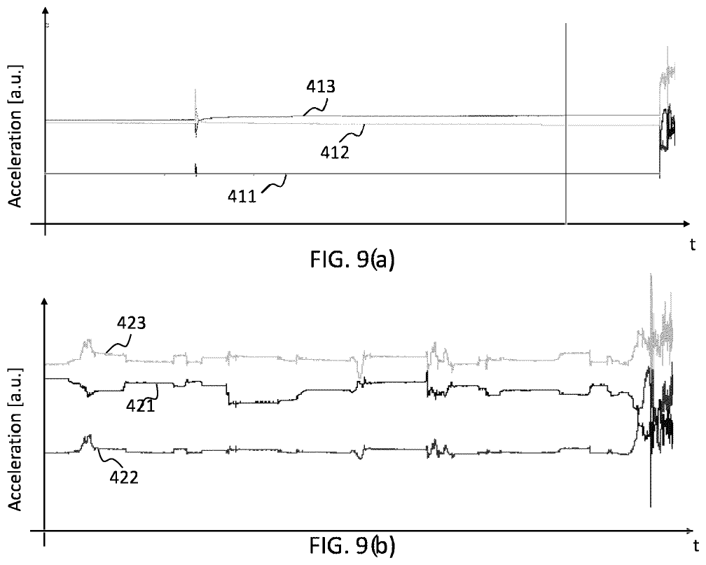

FIG. 4 to FIG. 9 illustrate the acceleration measurements using an example device according to an embodiment of the present solution. Subfigure (a) of said figures illustrates the monitored acceleration data in at least one dimension specific to hunting behavior of an individual cat while the cat is hunting a mouse. Similarly, subfigure (b) of said figures illustrates the monitored acceleration data in at least one dimension specific to hunting behavior of an individual cat while the cat is hunting a bird.

In FIG. 4 to FIG. 9, Y-axis and X-axis of the subfigures (a) and (b) are acceleration in arbitrary unit and time, respectively. The recording time of the acceleration data shown in FIG. 4 to FIG. 9 is approximately 1 minute. The at least one dimension comprises or is at least one physical dimension in Cartesian coordinate (X-, Y-, and Z-axis).

According to an embodiment, a 14 gram data logger, is attached to the neck of cats with a regular cat collar. The data logger records, at the rate of 16 Hz, the acceleration in two or three physical dimensions as shown in FIG. 4 to FIG. 9. The acceleration data recorded during a cat hunting a mouse, in particular in a first dimension 411, a second dimension 412, and a third dimension 413, fluctuates minimally. That is, the cats sit very quietly, without any obvious movements, for at least about one minute. In contrast, the acceleration data recorded during a cat hunting a bird, in particular in a first dimension 421, a second dimension 422, and a third dimension 423, show many local fluctuations which is indicative of small muscular movements despite a generally stationary position. Cats often hunt birds while standing still, but flexing and bending their musculature continuously such as to be maximally prepared to jump at the target during every instant.

It is obvious for a skilled person in the art to examine the acceleration data and distinguish the hunting behaviour of a cat, when the cat hunts a mouse and a bird. According to an embodiment, an artificial intelligence (AI) algorithm is trained to recognize the difference in hunting behaviour, and is able to detect hunting behaviour for birds with high accuracy. In case of false negative alerts, no harm is done as such alerts simply indicate that a cat is present, even if the cat is not hunting. According to an embodiment, a supervised machine learning approach is used, where the recorded hunting examples are used as annotated training data for the algorithm, which will then replicate the annotation on new (i.e., live) data. When using fine-scale 3D-acceleration data, recorded at high frequencies and high resolutions, the algorithm learns and detects decision boundaries based on the smallest of movements.

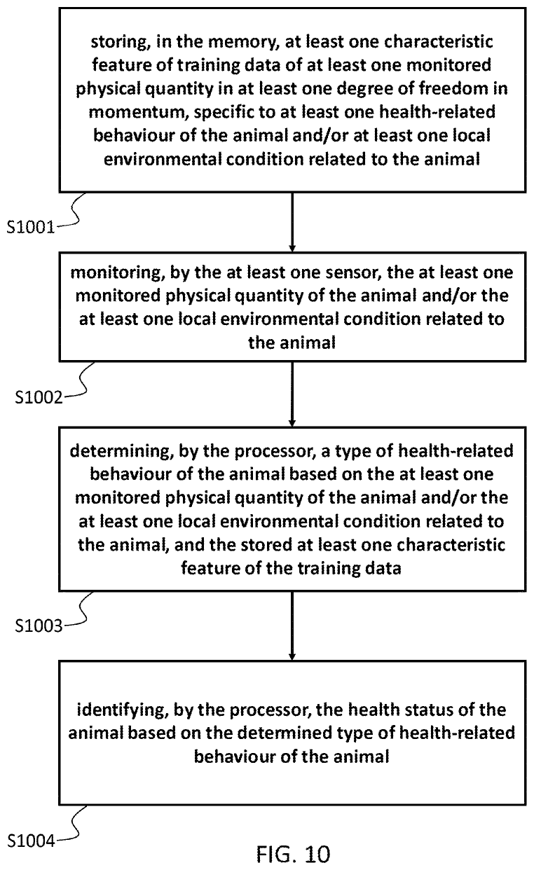

FIG. 10 illustrates a flowchart of a method for identifying a health status of an animal to be carried out on a device attached to the animal, the device comprising a memory, at least one sensor, and a processor. At S1001, at least one characteristic feature of training data of at least one monitored physical quantity in at least one degree of freedom in momentum, specific to at least one health-related behaviour of the animal and/or at least one local environmental condition related to the animal is stored in the memory. At S1002, the at least one monitored physical quantity of the animal and/or the at least one local environmental condition related to the animal is monitored by the at least one sensor. At S1003, a type of health-related behaviour of the animal is determined by the processor based on the at least one monitored physical quantity of the animal and/or the at least one local environmental condition related to the animal, and the stored at least one characteristic feature of the training data. At S1004, the health status of the animal is identified by the processor based on the determined type of health-related behaviour of the animal.

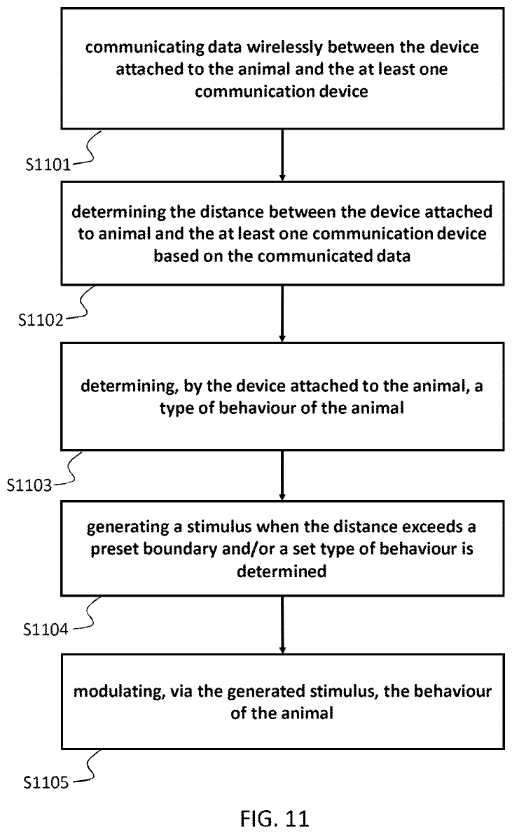

FIG. 11 illustrates a flowchart of a method for modulating the behaviour of an animal to be carried out on a system comprising a device attached to the animal and at least one communication device. At S1101, data is communicated wirelessly between the device attached to the animal and the at least one communication device. S1102, the distance between the device attached to animal and the at least one communication device are determined based on the communicated data. At S1103, a type of behaviour of the animal is determined by the device attached to the animal. At S1104, a stimulus is generated when the distance exceeds a pre-set boundary and/or a set type of behaviour is determined. At S1105, the behaviour of the animal is modulated via the generated stimulus.

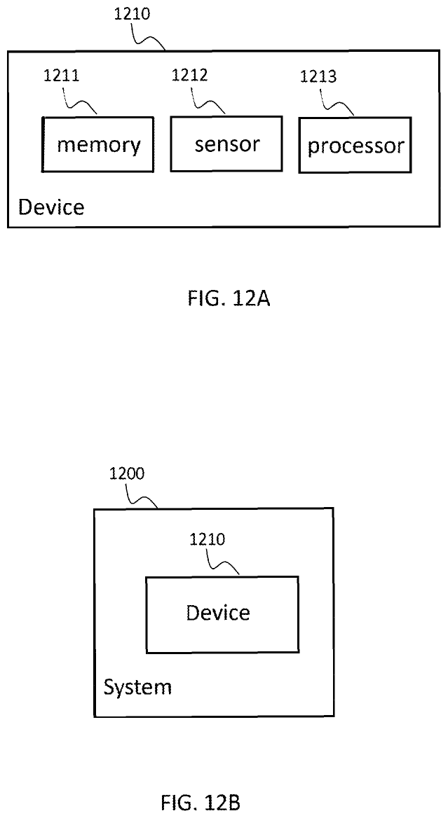

FIG. 12A illustrates a device 1210 for identifying a health status of an animal to be carried out on the device 1210 attached to the animal, the device comprising: a memory 1211 configured to store at least one extracted characteristic feature of training data of at least one monitored physical quantity in at least one degree of freedom in momentum, specific to at least one health-related behaviour of the animal and/or at least one local environmental condition related to the animal; at least one sensor 1212 configured to monitor the at least one monitored physical quantity of the animal and/or the at least one local environmental condition related to the second animal; a processor 1213 configured to determine a type of health-related behaviour of the animal based on the monitored at least one monitored physical quantity of the second animal and/or the at least one local environmental condition related to the animal, and the stored at least one extracted characteristic feature of the training data; and configured to identify the health status of the second animal based on the determined type of health-related behaviour of the animal. FIG. 12B illustrates a system 1200 for identifying a health status of an animal to be carried out on a device attached to the animal, the system comprising the device 1210 according to any one of the above-described embodiments.

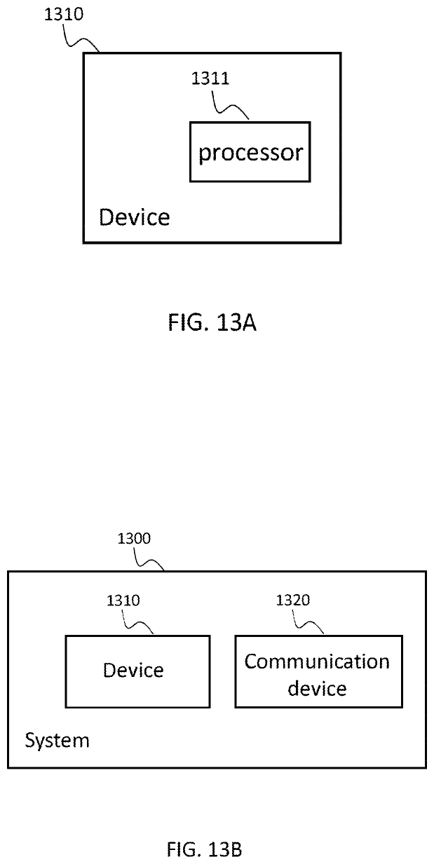

FIG. 13A illustrates a device 1310 for modulating the behaviour of an animal to be carried out on a system comprising the device attached to the animal and at least one communication device, the device comprising a processor 1311 being configured to: communicate data wirelessly between the device attached to the animal and the at least one communication device; determine the distance between the device attached to animal and the at least one communication device based on the communicated data; determine, by the device attached to the animal, a type of behaviour of the animal; generate a stimulus when the distance exceeds a pre-set boundary and/or a set type of behaviour is determined; and modulate, via the generated stimulus, the behaviour of the animal. FIG. 13B illustrates a system 1300 for modulating the behaviour of an animal to be carried out on the system comprising a device attached to the animal and at least one communication device, the system comprising the device 1310 according to any one of the above-described embodiments and the at least one communication device 1320.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the present solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present solution should not be limited by any of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present solution. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative methods, logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

The solution further to the following below items:

The above described further embodiments implemented in the method and device for animal behaviour modulation, i.e., determination of animal health-status and active behaviour modulation, can also be employed as independent methods and devices.

### Determination of the Health-Status

A method for identifying a health status of an animal to be carried out on a device attached to the animal, the device comprising a memory, at least one sensor, and a processor, the method comprising:
storing, in the memory, at least one characteristic feature of training data of at least one monitored physical quantity in at least one degree of freedom in momentum, specific to at least one health-related behaviour of the animal and/or at least one local environmental condition related to the animal;
monitoring, by the at least one sensor, the at least one monitored physical quantity of the animal and/or the at least one local environmental condition related to the animal;
determining, by the processor, a type of health-related behaviour of the animal based on the at least one monitored physical quantity of the animal and/or the at least one local environmental condition related to the animal, and the stored at least one characteristic feature of the training data; and
identifying, by the processor, the health status of the animal based on the determined type of health-related behaviour of the animal.

The method of item A1, wherein the identifying the health status of the animal comprises or is:
determining, by the processor, when the determined type of the health-related behaviour corresponds to a set type of health-related behaviour, whether the determined type of health-related behaviour is indicative of a normal health status or an abnormal health status, in particular by comparing at least one parameter related to the determined type of health-related behaviour to a reference value.

The method of item A2, wherein the set type of health-related behaviour comprises or is drinking, scratching, interest in the anorectal region, defecation, coughing, or grooming.

The method of any one of items A1 to A3, wherein the identifying the health status of the animal further comprises:
determining, by the processor, that the determined type of health-related behaviour is indicative of an abnormal health status when the determined type of health-related behaviour corresponds to a set type of health-related behaviour specific for an abnormal health status indicated by the stored at least one characteristic feature.

The method of any one of items A2 to A4, wherein the at least one parameter is a frequency of occurrence and/or duration of the determined type of health-related behaviour, a magnitude of the at least one monitored physical quantity, and/or a waveform of the at least one monitored physical quantity.

The method of any one of items A1 to A5, wherein the reference value is a range of values and is based on the average at least one parameter specific to the at least one health-related behaviour of the individual animal and/or a population of individuals of the same species of the animal.

The method of any one of items A2 to A6, wherein the identified abnormal health status is a renal insufficiency, flea infestations, worm infestations and/or filled anal glands, and/or gastric- and intestinal problems.

The method of item A7, wherein the identifying the renal insufficiency is based on determining a drinking behaviour specific for renal insufficiency and/or a difference of the determined drinking behaviour compared to the reference value, in particular, increased frequency and/or duration of drinking behaviour.

The method of item A7, wherein the identifying the worm infestations and/or filled anal glands is based on determining an interest in the anorectal region specific for worm infestations and/or filled anal glands, and/or a difference of the determined interest in the anorectal region compared to the reference value, in particular, increased frequency and/or duration of the in the anorectal region.

The method of item A7, wherein the identifying gastric- and intestinal problems is based on determining a defecation behaviour specific for gastric- and intestinal problems and/or a difference of the determined defecation behaviour compared to the reference value, in particular, increased or reduced frequency and/or duration of the defecation behaviour.

The method of any one of items A1 to A10, further comprising sending a warning message, in particular to a person responsible for the animal and/or a veterinarian.

The method of any one of items A1 to A11, further comprising storing, in the memory, at least one characteristic feature of the determined behaviours.

The method of any of items A1 to A12, further comprising generating a stimulus, by the device attached to the animal, wherein the stimulus is a stimulus to which the animal is conditioned to exhibit a specific behaviour.

The method of item A13, wherein the stimulus is generated by manual activation of the device attached to the animal, in particular via wireless communication, is generated by determining a set type of health-related behaviour and/or is generated by identifying a set type of health status.

The method of item A13 or A14, wherein the specific behaviour is moving to a specific position, in particular the home of the animal.

The method of any one of items A13 or A15, wherein the stimulus is a clicker sound.

A device for identifying a health status of an animal to be carried out on the device attached to the animal, the device comprising:
a memory configured to store at least one extracted characteristic feature of training data of at least one monitored physical quantity in at least one degree of freedom in momentum, specific to at least one health-related behaviour of the animal and/or at least one local environmental condition related to the animal;
at least one sensor configured to monitor the at least one monitored physical quantity of the animal and/or the at least one local environmental condition related to the second animal;
a processor configured to determine a type of health-related behaviour of the animal based on the monitored at least one monitored physical quantity of the second animal and/or the at least one local environmental condition related to the animal, and the stored at least one extracted characteristic feature of the training data; and configured to identify the health status of the second animal based on the determined type of health-related behaviour of the animal.

The device of item A17, wherein the processor is further configured to identify the health status of the second animal by performing, in particular determining when the determined type of the health-related behaviour corresponds to a set type of health-related behaviour, whether the determined type of health-related behaviour is indicative of a normal health status or an abnormal health status, more particularly by comparing at least one parameter related to the determined type of health-related behaviour to a reference value.

The device of item A17 or A18, wherein the set type of health-related behaviour comprises or is drinking, scratching, interest in the anorectal region, defecation, coughing, or grooming.

The device of any one of items A16 to A19, wherein the processor is being configured to identify the health status of the animal, in particular by performing:

Determining that the determined type of health-related behaviour is indicative of an abnormal health status when the determined type of health-related behaviour corresponds to a set type of health-related behaviour specific for an abnormal health status indicated by the stored at least one characteristic feature.

The device of any one of items A17 and A20, wherein the at least one parameter is a frequency of occurrence and/or duration of the determined type of health-related behaviour, a magnitude of the at least one monitored physical quantity, and/or a waveform of the at least one monitored physical quantity.

The device of any one of items A17 to A21, wherein the reference value is a range of values and is based on the average at least one parameter specific to the at least one health-related behaviour of the individual second animal and/or a population of individuals of the same species of the second animal.

The device of any one of items A17 to A22, wherein the identified abnormal health status is a renal insufficiency, flea infestations, worm infestations and/or filled anal glands, and/or gastric- and intestinal problems.

The device of item A23, wherein the processor is further configured to identify the renal insufficiency in particular based on determining a drinking behaviour specific for renal insufficiency and/or a difference of the determined drinking behaviour compared to the reference value, in particular, increased frequency and/or duration of drinking behaviour.

The device of any one of items A17 to A24, wherein the processor is further configured to identify the worm infestations and/or filled anal glands in particular based on performing determining an interest in the anorectal region specific for worm infestations and/or filled anal glands, and/or a difference of the determined interest in the anorectal region compared to the reference value, in particular, increased frequency and/or duration of the in the anorectal region.

The device of any one of items A17 to A25, wherein the processor is further configured to identify gastric- and intestinal problems in particular based on performing determining a defecation behaviour specific for gastric- and intestinal problems and/or a difference of the determined defecation behaviour compared to the reference value, in particular, increased or reduced frequency and/or duration of the defecation behaviour.

The device of any one of items A17 to A26, the device is further configured to send a warning message, in particular to a person responsible for the animal and/or a veterinarian.

The device of any one of items A17 to A27, the memory is further configured to store at least one characteristic feature of the determined behaviours.

The device of any of items A17 to A28, the device is further configured to generate a stimulus, by the device attached to the animal, wherein the stimulus is a stimulus to which the animal is conditioned to exhibit a specific behaviour.

The device of item A29, wherein the stimulus is generated by manual activation of the device attached to the animal, in particular via wireless communication, is generated by determining a set type of health-related behaviour and/or is generated by identifying a set type of health status.

The device of item A29 or A30, wherein the specific behaviour is moving to a specific position, in particular the home of the animal.

The device of any one of items A29 or A31, wherein the stimulus is a clicker sound.

A system for identifying a health status of an animal to be carried out on a device attached to the animal, the system comprising the device according to any one of the above-described embodiments.

### Location-Based Behaviour Modulation

A method for modulating the behaviour of an animal to be carried out on a system comprising a device attached to the animal and at least one communication device, the method comprising:
communicating data wirelessly between the device attached to the animal and the at least one communication device;
determining the distance between the device attached to animal and the at least one communication device based on the communicated data;
determining, by the device attached to the animal, a type of behaviour of the animal;
generating a stimulus when the distance exceeds a pre-set boundary and/or a set type of behaviour is determined; and
modulating, via the generated stimulus, the behaviour of the animal.

The method of item B1, wherein the stimulus is generated, by the at least one communication device and/or the device attached to the animal, by determining a distance below a set threshold distance between the device attached to animal and the at least one communication device.

The method of any one of items B1 or B2, further comprising:
identifying, via GPS, the position of the animal; and
generating, by the device attached to the animal, a stimulus based on determining a set position of the animal.

The method of any of items B1 to B3, wherein the set type of behaviour is scratching on an object, in particular furniture, defecation behaviour and/or hunting behaviour.

The method of any one of items B1 to B4, wherein the generated stimulus is an adverse stimulus.

The method of any one of items B1 to B6, wherein the intensity of the generated stimulus increases with decreasing distance to the communication device and/or set position; and/or with increasing time at a distance below a set threshold distance to the communication device and/or at the set position.

The method of any one of items B1 to B6, wherein modulating the behaviour of the animal is modulating the animal to increase the distance of the animal to the communication device and/or the set position.

The method of any one of items B1 to B7, wherein the generated stimulus conditions the animal to avoid the communication device, the set position and/or the set type of behaviour.

The method of any one of items B1 to B4, wherein the generated stimulus is a stimulus to which the animal is conditioned/trained to exhibit a specific behaviour, in particular returning to their home.

The method of item B9, wherein the stimulus is a clicker sound.

The method of any one of items B1 to B10, wherein the signal is generated by manual activation, in particular via wireless communication, of the device attached to the animal and/or the communication device.

A device for modulating the behaviour of an animal to be carried out on a system comprising the device attached to the animal and at least one communication device, the device comprising a processor being configured to:
communicate data wirelessly between the device attached to the animal and the at least one communication device;
determine the distance between the device attached to animal and the at least one communication device based on the communicated data;
determine, by the device attached to the animal, a type of behaviour of the animal;
generate a stimulus when the distance exceeds a pre-set boundary and/or a set type of behaviour is determined; and
modulate, via the generated stimulus, the behaviour of the animal.

The device of item B12, wherein the stimulus is generated, by the at least one communication device and/or the device attached to the animal, by determining a distance below a set threshold distance between the device attached to animal and the at least one communication device.

The device of any one of items B12 or B13, wherein the processor is further configured to:
identify, via GPS, the position of the animal; and
generate, by the device attached to the animal, a stimulus based on determining a set position of the animal.

The device of any of items B12 to B14, wherein the set type of behaviour is scratching on an object, in particular furniture, defecation behaviour and/or hunting behaviour.

The device of any one of items B12 to B15, wherein the generated stimulus is an adverse stimulus.

The device of any one of items B12 to B16, wherein the intensity of the generated stimulus increases with decreasing distance to the communication device and/or set position; and/or with increasing time at a distance below a set threshold distance to the communication device and/or at the set position.

The device of any one of items B12 to B17, wherein the device is configured to modulate the behaviour of the animal in particular by performing modulating the animal to increase the distance of the animal to the communication device and/or the set position.

The device of any one of items B12 to B18, wherein the generated stimulus conditions the animal to avoid the communication device, the set position and/or the set type of behaviour.

The device of any one of items B12 to B19, wherein the generated stimulus is a stimulus to which the animal is conditioned/trained to exhibit a specific behaviour, in particular returning to their home.

The device of item B20, wherein the stimulus is a clicker sound.

The device of any one of items B12 to B21, wherein the signal is generated by manual activation, in particular via wireless communication, of the device attached to the animal and/or the communication device.

A system for modulating the behaviour of an animal to be carried out on the system comprising a device attached to the animal and at least one communication device, the system comprising the device according to any one of the above-described embodiments and the at least one communication device.

1. A method for animal behaviour modulation of at least one first animal to be carried out on a device attached to a second animal, the device comprising a memory, at least one sensor, a processor, and a signal generator and the method comprising:
storing, in the memory, at least one extracted characteristic feature of training data of at least one monitored physical quantity in at least one of: at least one degree of freedom in momentum, specific to at least one behaviour of the second animal, or at least one local environmental condition related to the second animal;
monitoring, by the at least one sensor, at least one of: the at least one monitored physical quantity of the second animal, or the at least one local environmental condition related to the second animal;
determining, by the processor, a type of behaviour of the second animal based on at least one of: the at least one monitored physical quantity of the second animal, or the at least one local environmental condition related to the second animal, and the stored at least one extracted characteristic feature of the training data; and
generating, by the signal generator, a warning signal based on the determining a first set type of behaviour of the second animal, so that the warning signal induces the behaviour modulation of the at least one first animal.

2. The method of claim 1, wherein the behaviour modulation comprises induction of flight behaviour.

3. The method of claim 1, wherein the behaviour of the second animal is not modulated.

4. The method of claim 1, wherein the at least one first animal is a prey, comprising a bird.

5. The method of claim 1, wherein the second animal is a predator, comprising a felid.

6. The method of claim 1, wherein the at least one sensor monitoring the at least one monitored physical quantity of the second animal comprises or is a Micro-Electro-Mechanical Systems (MEMS), comprising at least one of: an inertial measurement unit (IMU), a magnetometer, a microphone, or a pressure sensor.

7. The method of claim 1, wherein the at least one local environmental condition comprises or is a pressure, a humidity, a sound pressure in a vicinity of the second animal.

8. The method of claim 1, wherein the first set type of behaviour of the second animal is a hunting behaviour, comprising a behaviour of hunting a bird.

9. The method of claim 1, wherein the warning signal is not generated based on a determined second set type of behaviour of the second animal, wherein the second set type of behaviour of the second animal is hunting a rodent.

10. The method of claim 1, wherein the warning signal is a sound that is at least audible to the at least one first animal, wherein the sound mimics a naturally occurring warning sound.

11. The method of claim 1, wherein the signal generator comprises or is a piezoelectric transducer.

12. A device for animal behaviour modulation of at least one first animal attached to a second animal, wherein the device comprises:
a memory configured to store at least one extracted characteristic feature of training data of at least one monitored physical quantity in at least one degree of freedom in momentum, specific to at least one of: at least one behaviour of the second animal, or at least one local environmental condition related to the second animal;
at least one sensor configured to monitor at least one of: the at least one monitored physical quantity of the second animal, or the at least one local environmental condition related to the second animal;
a processor configured to determine a type of behaviour of the second animal based on the monitored at least one of: the at least one monitored physical quantity of the second animal, or the at least one local environmental condition related to the second animal, and the stored at least one extracted characteristic feature of the training data; and
a signal generator configured to generate a warning signal based on the determining a first set type of behaviour of the second animal, so that the warning signal induces the behaviour modulation of the at least one first animal.

13. The device of claim 12, wherein the behaviour modulation comprises induction of flight behaviour.

14. The device of claim 12, wherein the behaviour of the second animal is not modulated.

15. The device of claim 12, wherein the at least one first animal is a prey, comprising a bird.

16. The device of claim 12, wherein the second animal is a predator, comprising a felid.

17. The device of claim 12, wherein the at least one sensor monitoring at least one motion parameter of the second animal comprises or is a Micro-Electro-Mechanical Systems (MEMS), comprising at least one of: an inertial measurement unit (IMU), a magnetometer, a microphone, or a pressure sensor.

18. The device of claim 12, wherein the at least one local environmental condition comprises or is a pressure, a humidity, a sound pressure in a vicinity of the second animal.

19. The device of claim 12, wherein the first set type of behaviour of the second animal is a hunting behaviour, comprising a behaviour of hunting a bird.

20. The device of claim 12, wherein the warning signal is not generated based on a determined second set type of behaviour of the second animal, wherein the second set type of behaviour of the second animal is hunting a rodent.

21. The device of claim 12, wherein the warning signal is a sound that is at least audible to the at least one first animal, wherein the sound mimics a naturally occurring warning sound.

22. The device of claim 12, wherein the signal generator comprises or is a piezoelectric transducer.
